(19) United States
(12) Patent Application Publication
(10) Pub. No.: US 2019/0197497 A1
(43) Pub. Date: Jun. 27, 2019

(54) RESPONSES TO DETECTED IMPAIRMENTS

(71) Applicant: Lyft, Inc., San Francisco, CA (US)

(72) Inventors: Farzad Cyrus Foroughi Abari, San Bruno, CA (US); Aaron Jacob Levine Friedman, San Francisco, CA (US); John Houston, San Francisco, CA (US); Adam Hart Reis, San Francisco, CA (US); Alexander Thomas Starns, Menlo Park, CA (US)

(21) Appl. No.: 15/852,604

(22) Filed: Dec. 22, 2017

(51) Int. Cl. G06Q 10/00; G05D 1/00

(52) U.S. Cl. CPC G06Q 10/20; G05D 1/0027; G05D 1/0088

(57) ABSTRACT

In particular embodiments, a computing system may receive an indication of an impaired sensor component from a first autonomous vehicle. The system may identify a sensor type of the impaired sensor component and determine a suitable service center for servicing the sensor type based on one or more criteria. The system may identify a second autonomous vehicle. The second autonomous vehicle has a functional sensor component of the sensor type. The system may send instructions to the second autonomous vehicle to drive to a location of the first autonomous vehicle and share sensor data from the functional sensor component with the first autonomous vehicle. The first autonomous vehicle may be instructed to drive to the service center location using sensor data of the second autonomous vehicle. The second autonomous vehicle may be instructed to drive to the service center location with the first autonomous vehicle.

### BACKGROUND

When an autonomous vehicle requires a service need or is impaired, it is often challenging to detect what type of service is required by the vehicle and how to best respond to the service need/impairment as there is no human driver present in the autonomous vehicle. For instance, an autonomous vehicle may have one or more faulty sensor components (e.g., GPS, LiDAR, etc.), may require a major service need (e.g., due to engine overheating, flat tire, etc.), may require a minor or a common service need (e.g., car wash, windshield fluid, etc.), and/or may need to be scheduled for its regular maintenance (e.g., yearly service, 10K miles service, etc.). Autonomous vehicles are not designed to manage their own maintenance and address impairments. Anytime an issue occurs in an autonomous vehicle, the vehicle generally has to return to a central location from where a required service need is analyzed and taken care of, which can be very inefficient and impractical. Additionally, if an autonomous vehicle is unable to drive autonomously due to an impairment or service need, generally human assistance would be required to arrive at a location of the vehicle and tow the vehicle away to a service center, which is time consuming and costly.

### BRIEF DESCRIPTION OF THE DRAWINGS

FIGS. 1A and 1B illustrate two example scenarios of how a functional autonomous vehicle may provide services to an impaired autonomous vehicle.

FIG. 2 illustrates an example block diagram of a transportation management environment.

FIGS. 3A-3F illustrate an example method for providing responses to service needs of an impaired autonomous vehicle, in accordance with particular embodiments.

FIGS. 4A-4C illustrate an example of a transportation management vehicle device.

FIG. 5 illustrates an example block diagram of a transportation management environment for matching ride requestors with autonomous vehicles.

FIG. 6 illustrates an example of a computing system.

### DESCRIPTION OF EXAMPLE EMBODIMENTS

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described. In addition, the embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g., method, can be claimed in another claim category, e.g., system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

When an autonomous vehicle requires a service need or is impaired, it is often challenging to detect what type of service is required by the vehicle and how to best respond to the service need/impairment as there is no human driver present in the autonomous vehicle. For instance, an autonomous vehicle may have one or more faulty sensor components (e.g., GPS, LiDAR, etc.), may require a major service need (e.g., due to engine overheating, flat tire, etc.), may require a minor or a common service need (e.g., car wash, windshield fluid, etc.), and/or may need to be scheduled for its regular maintenance (e.g., yearly service, 10K miles service, etc.). Autonomous vehicles are not designed to manage their own maintenance and address impairments. Even if they detect a problem, they would not know what to do, where to go, and when to go. If an autonomous vehicle is unable to drive autonomously due to an impairment or service need, generally human assistance would be required to arrive at a location of the vehicle and tow the vehicle away to a service center, which is time consuming and costly. Furthermore, an autonomous vehicle may be transporting one or more ride requestors (interchangeably referred herein as passengers) when something breaks down. Thus, in an event of a service need, an appropriate response needs to be provided relating to the impaired vehicle and its passengers.

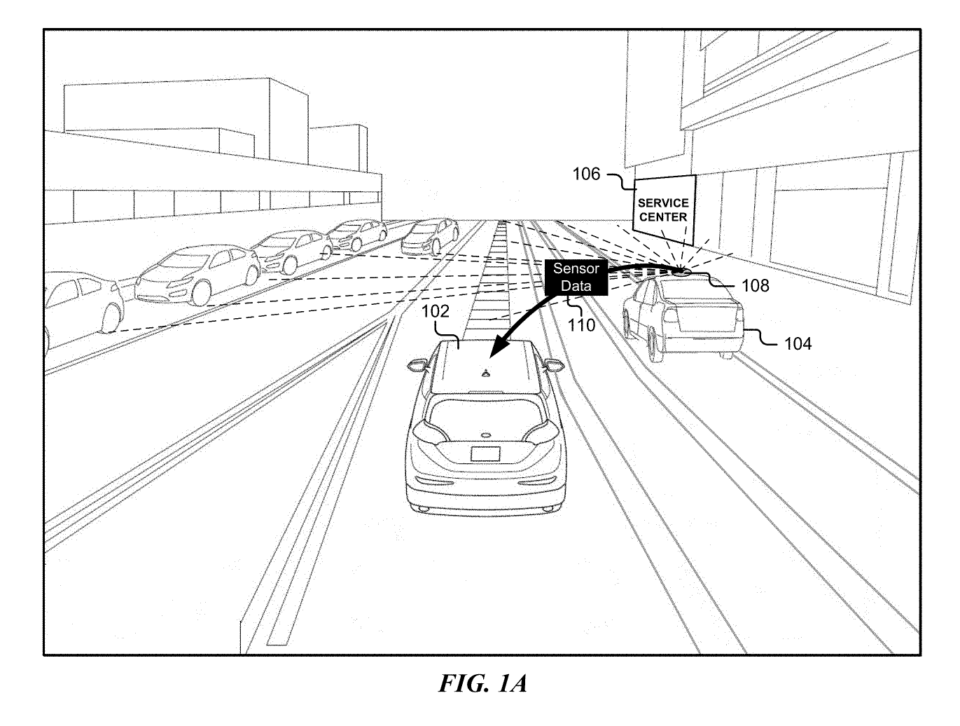

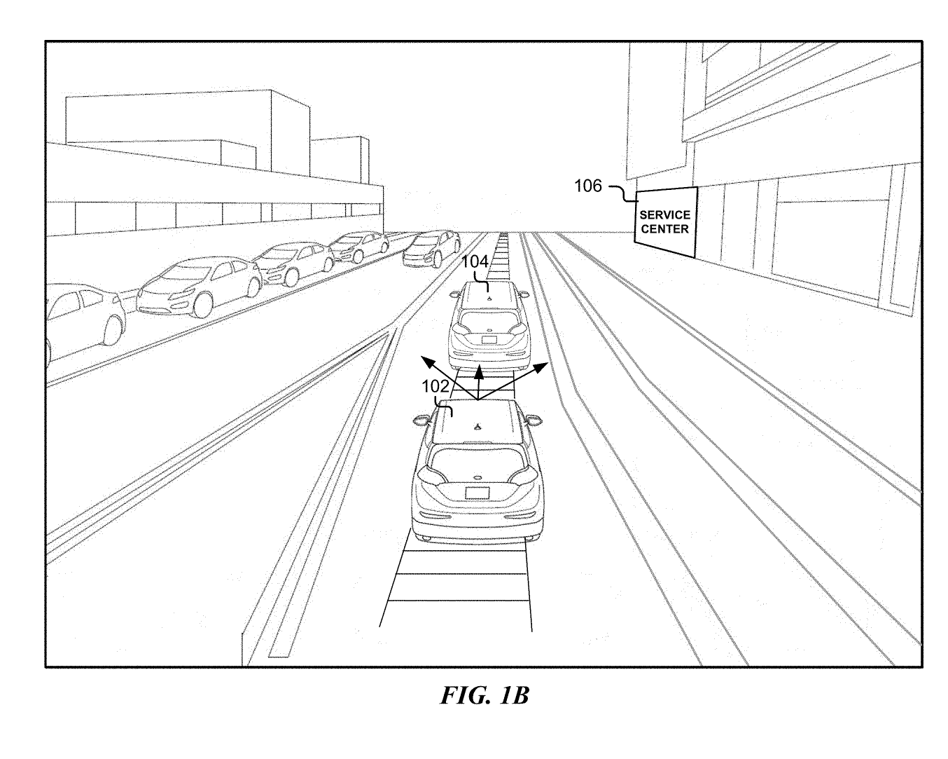

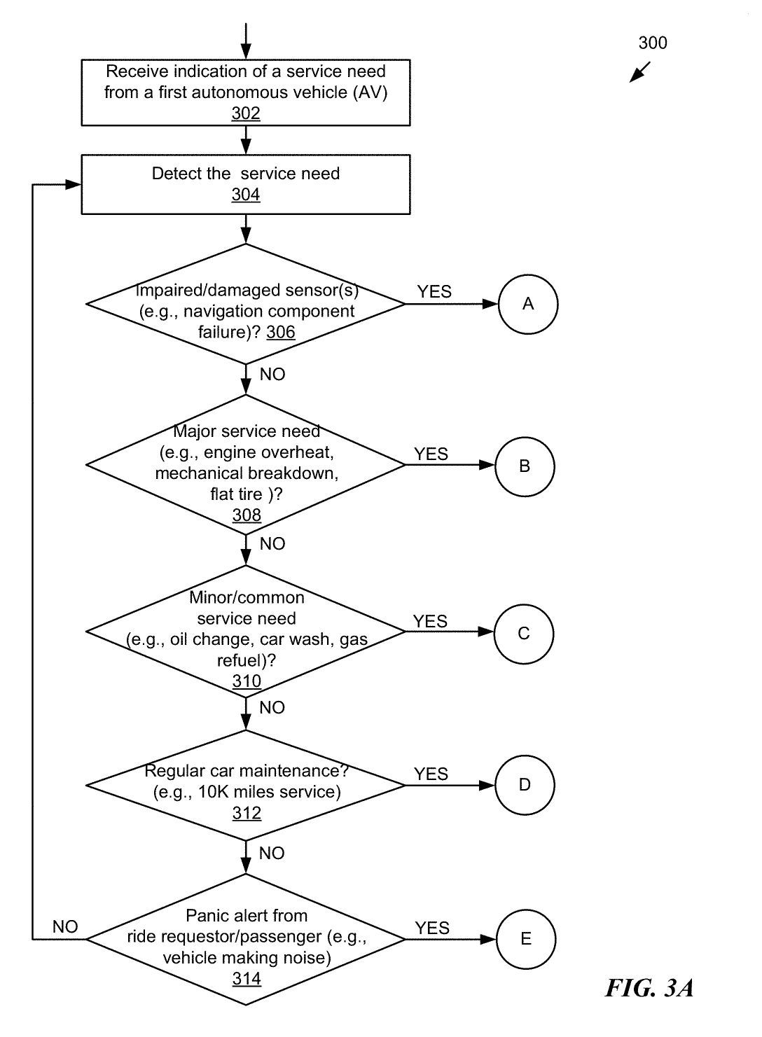

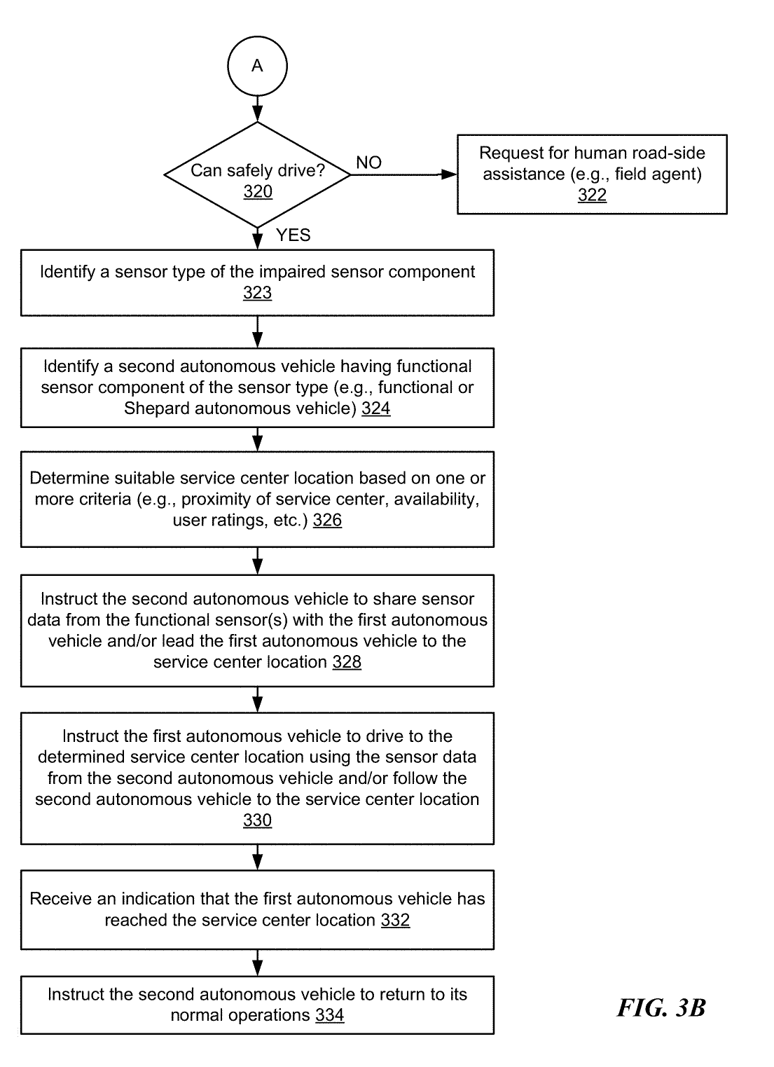

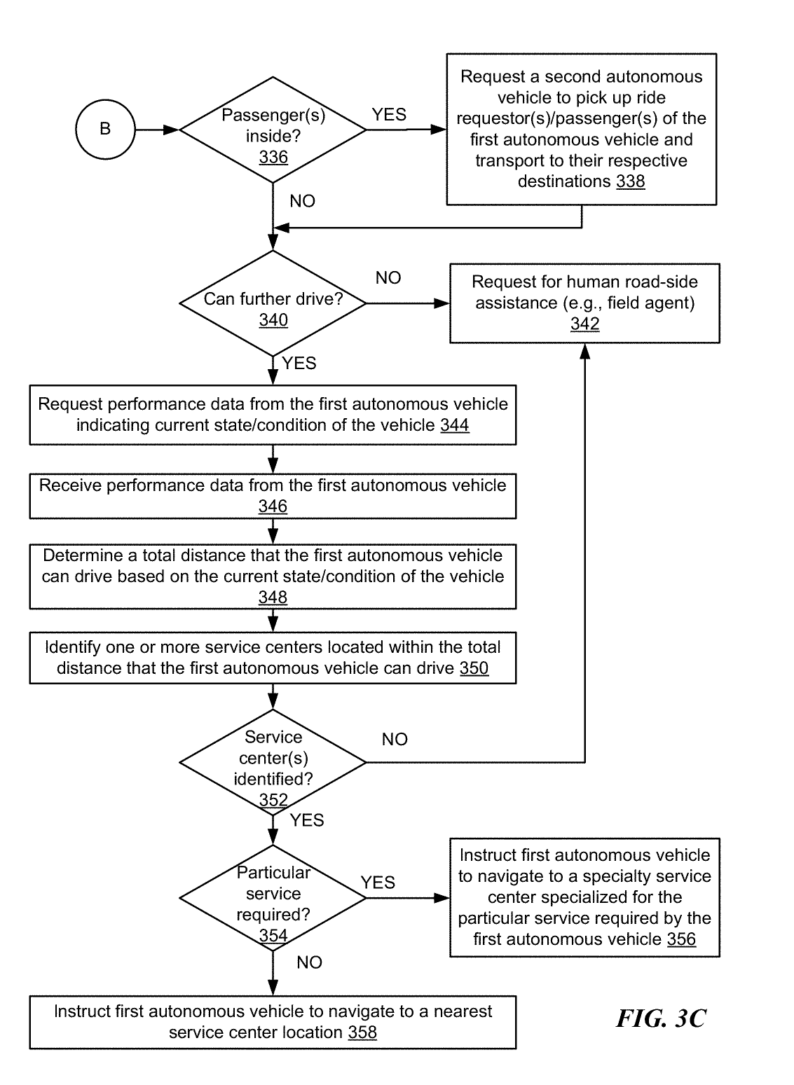

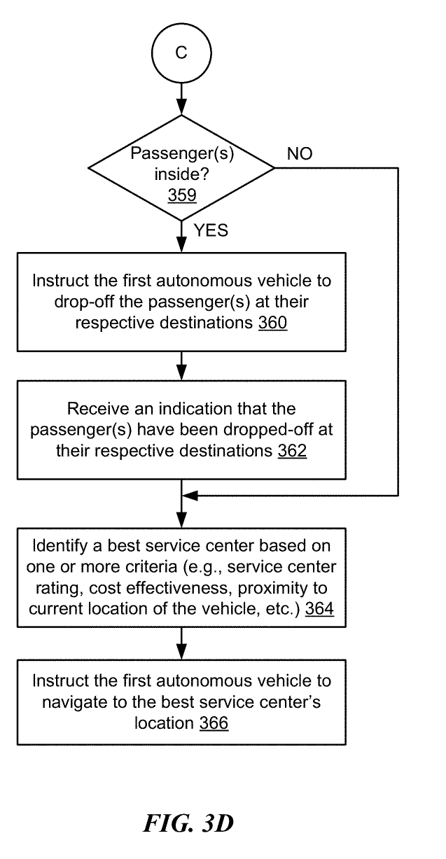

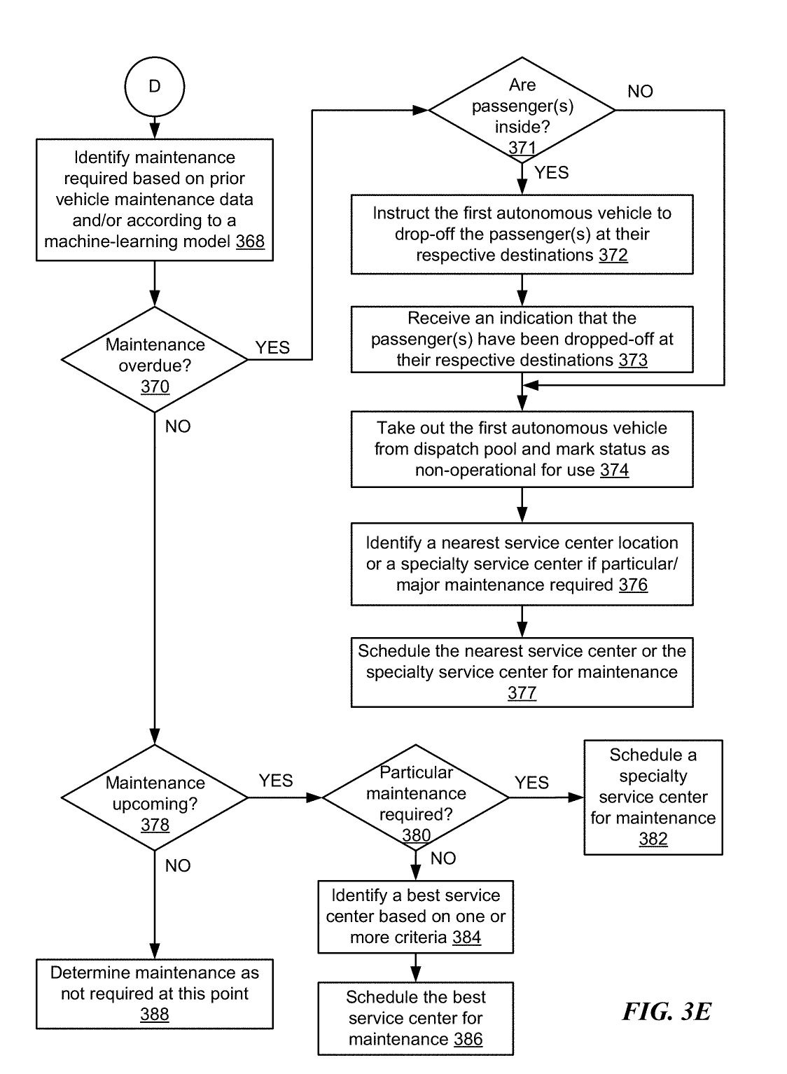

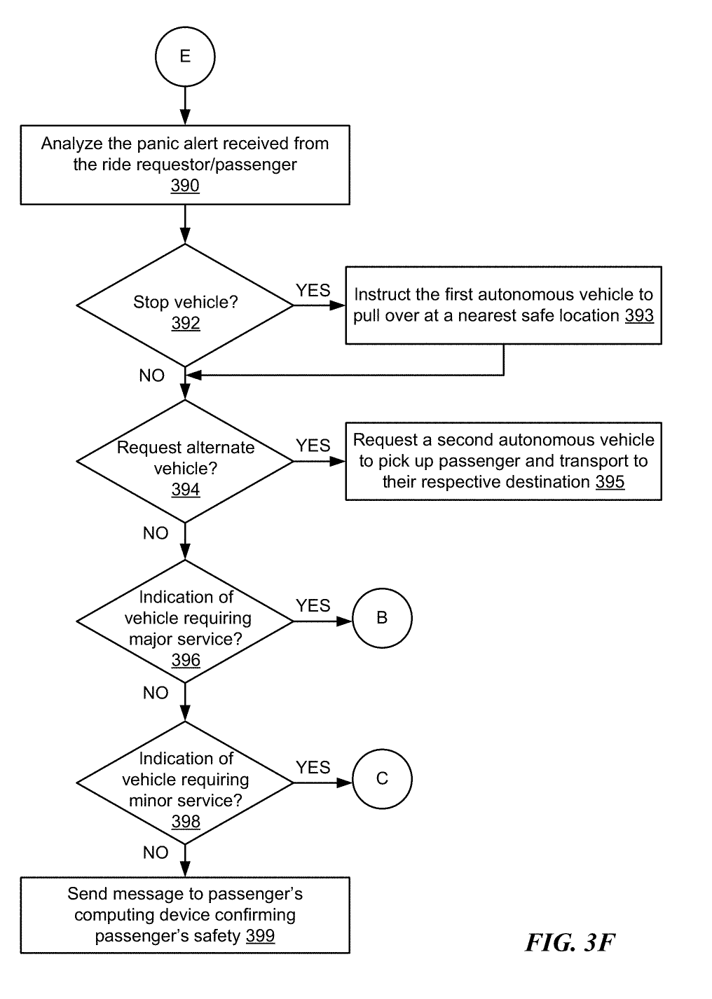

Particular embodiments described herein relates to systems, apparatuses, and methods for providing responses to service needs of an impaired autonomous vehicle. In particular embodiments, a central entity or system managing a fleet of various autonomous vehicle, such as a transportation management system, may be able to manage different service needs of an impaired autonomous vehicle. By way of a first example and with reference to FIG. 1A, an autonomous vehicle 102 may have a faulty or impaired sensor, such as an object-detection sensor/component (e.g., LiDAR sensor), such that the vehicle 102 is not able to detect objects surrounding the vehicle and is unsafe to further drive. In this example, the transportation management system may request a second autonomous vehicle 104 with the functional sensor component 108 (also interchangeably referred sometimes as a Shepherd autonomous vehicle) to drive close to the impaired autonomous vehicle 102 and share its sensor data 110 (e.g., sense objects that are in front and share its sensor data with the impaired vehicle 102). The impaired vehicle 102 may use the sensor data 110 of the Shepherd vehicle 104 to drive to a service center 106 for repair. In particular embodiments, the two autonomous vehicles 102 and 104 may need to drive in a close proximity of each other or within a certain threshold distance in order for the second autonomous vehicle 104 to successfully share relevant data 110 with the first vehicle 102. If the two vehicles 102 and 104 are not in close proximity or located far apart then sensor data of the Shepherd vehicle 104 may not accurately represent or sense the environment surrounding the impaired autonomous vehicle 102 (e.g., the sensor data representing environment surrounding the vehicle 104 may be different from the environment surrounding the vehicle 102). Also, if the vehicles are far apart or outside of a certain threshold distance, then sensor data from the Shepherd vehicle 104 may not be even sent (e.g., due to connection being outside of certain range), may reach incomplete, or may get corrupted during transfer. The Shepherd autonomous vehicle 104 may share its sensor data 110 with the impaired autonomous vehicle 102 either directly via a wireless communication channel (e.g., Bluetooth, NFC, Infrared, etc.) or via the transportation management system. The Shepherd autonomous vehicle 104 may also help the impaired vehicle 102 navigate by driving in front of the impaired vehicle 102 to lead it to the service center 106 for repair, as shown in FIG. 1B. Each of these two scenarios is discussed in detail in reference to FIG. 3B. Sharing sensor data from a functional or Shepherd autonomous vehicle to an impaired vehicle, or having the Shepherd vehicle to lead the impaired vehicle to a service center is advantageous as this keeps the impaired vehicle still running and operational (for a temporary time), and avoids the need for towing the impaired vehicle to the service center or calling a field agent if the impaired vehicle is determined safe to drive when provided with accurate sensor data or guidance. Also, if a passenger is riding in the impaired vehicle, then this also avoids any inconvenience to the passenger as the Shepherd vehicle can lead the impaired vehicle to the passenger's destination location to drop-off the passenger before leading the impaired vehicle to a service center location.

As another example of a response to a service need, the transportation management system may detect the severity and/or urgency of the service needed by an autonomous vehicle. For example, the transportation management system may determine that an autonomous vehicle needs a major service (e.g., due to mechanical failure, engine overheat, etc.) or a minor or a common service (e.g., oil change, car wash, gas refuel, washer fluid, etc.). Based on the type and urgency of service that the autonomous vehicle requires, the system may determine that the vehicle is still able to drive. In response, the system may identify one of a nearest service center (e.g., for vehicle with urgent and/or major service need), a specialty service center (e.g., for a particular type of service required by the vehicle for which a given service center specializes in), or a best service center (e.g., service center with high user rating/feedback and most cost-efficient for service repairs) for the autonomous vehicle, as shown and discussed in detail in reference to at least FIGS. 3C and 3D. Yet as another example of a response to a service need, the transportation management system may detect that an autonomous vehicle can no longer safely drive or is stuck (e.g., due to a flat tire). In this case, the system may request a human road-side assistance (also interchangeably referred sometimes as a field agent) to arrive at the current location of the autonomous vehicle and resolve the issue (e.g., by themselves or by calling a tow truck to take the impaired vehicle to a service center location or other specific maintenance service provider to provide a particular necessary service).

Yet as another example of a response to a service need, the transportation management system may schedule a maintenance service for a vehicle when a required maintenance (e.g., 10K miles service, 2 year maintenance, etc.) is upcoming or overdue, as discussed in detail below in reference to FIG. 3E. Yet as another example of a response to a service need, the transportation management system may respond to a service or alert explicitly indicated by a passenger of a vehicle. For instance, the passenger using a transportation application (running on a passenger's computing device) may indicate that the vehicle is having some issues (e.g., making noise, smoke coming out of vehicle, air conditioning not working, etc.) and the transportation management system may take an appropriate action accordingly, as discussed in further detail below in reference to FIG. 3F.

Providing a response to a major service need (e.g., engine overheat, flat tire, etc.), a minor service need (e.g., car wash, gas refuel, etc.), a panic alert from a passenger of the vehicle, or a regular vehicle maintenance, as discussed herein, is advantageous as autonomous vehicles generally do not know how to respond to different service needs because responding to these needs is beyond the typical capabilities of an autonomous vehicle, especially at the fleet level. By providing an appropriate response to each of these service needs, the transportation management system ensures that the autonomous vehicles are in their best operational condition (e.g., all parts/components properly working, fluids (e.g., break oil, engine oil, etc.) up to their required levels, vehicle maintenance is done at scheduled times, tire pressure is fine, vehicle is cleaned, etc.) and also ensures overall safety and convenience of passengers of the autonomous vehicles. This is also advantageous from an overall system or fleet level as currently when an impairment or issue occurs in an autonomous vehicle, the vehicle has to report to a central authority/location from where an appropriate service need is detected and provided, which is time consuming and inefficient. By detecting the various services needs required by a vehicle and providing an appropriate response to each of those service needs to the vehicle on the go (e.g., Shepherd vehicle provided for assisting an impaired vehicle, field agent requested to arrive at the impaired vehicle's location, impaired vehicle navigated to a nearest service center location, etc.), overall response time to resolve the service needs of an impaired vehicle is significantly reduced and less overload is put on the system as the system does not have to fulfill the service needs of a number of vehicles all at once. In any event of a service need, apart from fulfilling the service need of the impaired vehicle, the transportation management system may make sure to manage the needs of one or more passengers in the impaired vehicle. For instance, if a passenger is present in an impaired vehicle that requires service, then the transportation management system may request an alternate vehicle (e.g., autonomous or human-driven vehicle) to pick up the one or more passengers of the impaired vehicle and transport them to their respective destinations.

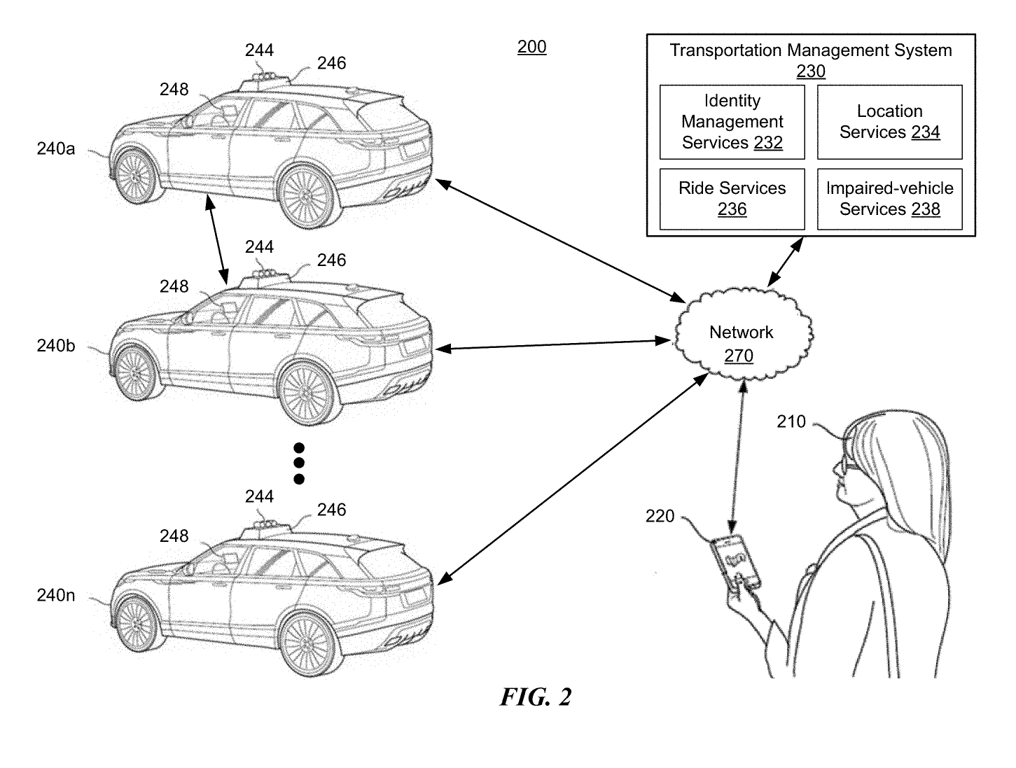

FIG. 2 shows an example transportation management environment 200, in accordance with particular embodiments. The transportation management environment 200 may include a ride requestor 210 with a computing device 220, a transportation management system 230, and a fleet of autonomous vehicles 240a . . . 240n (individually and/or collectively referred to herein as 240), connected to each other by a network 270. Although FIG. 2 illustrates a particular number of ride requestors 210, requestor's computing devices 220, transportation management systems 230, autonomous vehicles 240, and networks 270, this disclosure contemplates any suitable number of ride requestors 210, requestor's computing devices 220, transportation management systems 230, autonomous vehicles 240, and networks 270. As an example and not by way of limitation, transportation management environment 200 may include two or more ride requestors 210.

In particular embodiments, the requestor 210 may use a transportation application running on a requestor computing device 220 (e.g., smartphone, tablet computer, smart wearable device, laptop computer, etc.) to request a ride from a specified pick-up location to a specified drop-off location. The request may be sent over a communication network 270 to the transportation management system 230. The transportation management system 230 may fulfil ride requests by dispatching autonomous vehicles 240. For example, in response to a ride request, the transportation management system 230 may dispatch and instruct an autonomous vehicle 240a managed by the system to transport the requestor 210. In particular embodiments, a fleet of autonomous vehicles 240 may be managed by the transportation management system 230. The fleet of autonomous vehicles 240, in whole or in part, may be owned by the entity associated with the transportation management system 230, or they may be owned by a third-party entity relative to the transportation management system 230. In either case, the transportation management system 230 may control the operations of the autonomous vehicles 240, including, e.g., dispatching select vehicles 240 to fulfill ride requests, instructing the vehicles 240 to perform select operations (e.g., head to a service center or charging/fueling station, pull over, stop immediately, self-diagnose, lock/unlock compartments, change music station, change temperature, and any other suitable operations), and instructing the vehicles 240 to enter select operation modes (e.g., operate normally, drive at a reduced speed, drive under the command of human operators, and any other suitable operational modes).

Although not shown in FIG. 2, the transportation management system 230, in response to ride requests, may match the needs of ride requestors with ride providers (people driving vehicles by themselves) who are willing to use their human-driven vehicles to provide the requested rides. For instance, through a transportation application installed on a requestor's computing device 220, a ride requestor 210 may request for a ride from a starting location to a destination at a particular time. In response to the request, the transportation management system 230 may match the ride requestor's needs with any number of available ride providers and notify the matching ride providers of the ride request.

In particular embodiments, the transportation management system 230 may include software modules or applications, including, e.g., identity management services 232, location services 234, ride services 236, impaired-vehicle services 238, and/or any other suitable services. Although a particular number of services are shown as being provided by system 230, more or fewer services may be provided in various embodiments. In particular embodiments, identity management services 232 may be configured to, e.g., perform authorization services for ride requestors 210 and manage their interactions and data with the transportation management system 230. This may include, e.g., authenticating the identity of requestors 210 and determining that they are authorized to receive services from the transportation management system 230. Identity management services 232 may also manage and control access to requestor data maintained by the transportation management system 230, such as ride histories, vehicle data, personal data, preferences, usage patterns, profile pictures, linked third-party accounts (e.g., credentials for music or entertainment services, social-networking systems, calendar systems, task-management systems, etc.) and any other associated information. In particular embodiments, the transportation management system 230 may provide location services 234, which may include navigation and/or traffic management services and user interfaces. For example, the location services 234 may be responsible for querying device(s) associated with requester(s) 210 (e.g., computing device 220) for their locations. The location services 234 may also be configured to track those devices to determine their relative proximities, generate relevant alerts (e.g., proximity is within a threshold distance), generate navigation recommendations, and any other location-based services. In particular embodiments, the transportation management system 230 may provide ride services 236, which may include ride matching and management services to connect a requestor 210 to an autonomous vehicle 240. For example, after the identify of a ride requestor 210 has been authenticated by the identity management services module 232, the ride services module 236 may attempt to match the requestor with one or more autonomous vehicles 240. In particular embodiments, the ride services module 236 may identify an appropriate vehicle 240 using location data obtained from the location services module 234. The ride services module 236 may use the location data to identify a vehicle 240 that is geographically close to the requestor 210 (e.g., within a certain threshold distance or travel time). In particular embodiments, the impaired-vehicle services 238 may be responsible for providing responses to detected impairments or service needs of an impaired autonomous vehicle 240. The impaired-vehicle services 238 may receive an indication of an impairment or service need from the vehicle 240 or passenger(s) of the vehicle 240. For instance, data indicating the impairment or service need may be obtained using the identity management services 232, location services 234, and ride services 236, as well as from the requestor's computing device 220, and the vehicle 240. In particular embodiments, the impaired-vehicle services 238 may provide an appropriate response to a detected impairment or service need according to the method 300 as discussed in FIGS. 3A-3F.

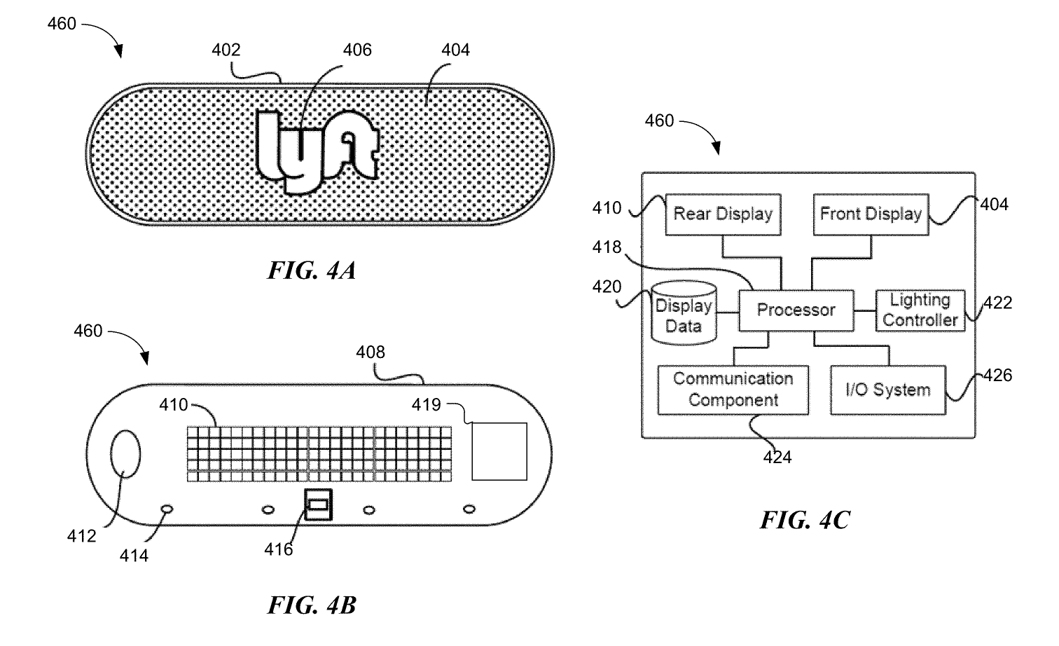

An autonomous vehicle 240 may be a vehicle that is capable of sensing its environment and navigating with little to no human input. The autonomous vehicle 240 may be equipped with a variety of systems or modules for enabling it to determine its surroundings and safely navigate to target destinations. In particular embodiments, the vehicle 240 may be equipped with an array of sensors 244, a navigation system 246, and a ride-service computing device 248. The sensors 244 may obtain and process sensor/telemetry data. For example, the sensors 244 may be optical cameras for, e.g., recognizing roads and lane markings; infrared cameras for, e.g., night vision; LiDARs for, e.g., detecting 360° surroundings; RADAR for, e.g., detecting distant hazards; stereo vision for, e.g., spotting hazards such as pedestrians or tree branches; wheel sensors for, e.g., measuring velocity; ultra sound for, e.g., parking and obstacle detection; global positioning system (GPS) for, e.g., determining the vehicle's current geolocation; and/or inertial measurement units, accelerometers, gyroscopes, and/or odometer systems for movement or motion detection. While the description of these sensors provides particular examples of utility, one of ordinary skill in the art would appreciate that the utilities of the sensors are not limited to these examples. The navigation system 246 may be responsible for safely navigating the autonomous vehicle 640. In particular embodiments, the navigation system 246 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. In particular embodiments, the navigation system 246 may use its determinations to control the vehicle 240 to operate in prescribed manners and to guide the autonomous vehicle 240 to its destinations without colliding into other objects. The ride-service computing device 248 may be a tablet or other suitable device installed by transportation management system 230 to allow a user to interact with the autonomous vehicle 240, transportation management system 230, or other users. Although not shown in FIG. 2, an autonomous vehicle 240 may also include a transportation management vehicle device (see FIGS. 4A-4C) that may be configured to easily and efficiently provide information to a requestor 210, obtain internal sensor data of the vehicle, adjust configurations of the vehicle, and send data to or receive data from the transportation management system 230.

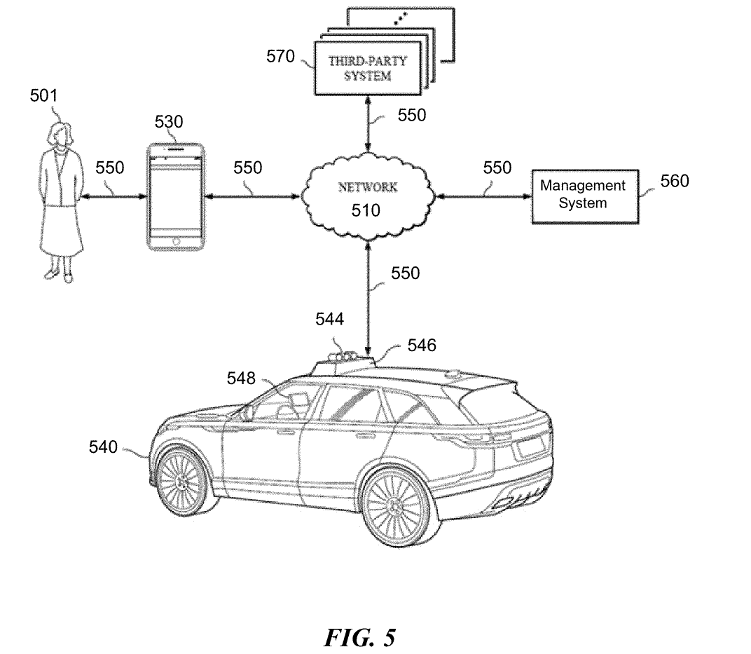

In particular embodiments, autonomous vehicles 240 may be able to communicate with each other either directly via a wireless communication channel (e.g., Bluetooth, NFC, Infrared, etc.) or via the transportation management system 230 by sending or receiving data through the network 270. In particular embodiments, when one of the autonomous vehicles is down (impaired autonomous vehicle), the transportation management system 230 may instruct a second autonomous vehicle (Shepherd autonomous vehicle) to help the impaired vehicle. As an example and not by way of limitation, vehicle 240a may be impaired due to one or more sensors 244 not working properly or being faulty, then the transportation management system 230 may instruct a second vehicle 240b to share its sensor data with the impaired vehicle 240a (see for example, FIG. 1A) or instruct the second vehicle 240b to lead the impaired vehicle 240a (see for example, FIG. 1B) to a nearby service center location, as discussed in detail below in reference to at least FIG. 3B. Additional description regarding one or more entities of FIG. 1 is provided below in reference to at least FIGS. 3A-3F and 5.

FIGS. 3A-3F illustrate an example method 300 for providing responses to service needs of an impaired autonomous vehicle, in accordance with particular embodiments. The method 300 begins at step 302, where the transportation management system may receive an indication of a service need from a first autonomous vehicle. For example, the first autonomous vehicle may be having some issues (e.g., engine overheat, low engine oil, low tire pressure, deflated tire, air conditioning not working, etc.), and consequently the autonomous vehicle may send an indication of the issue, the determined cause, and/or a combination thereof to the transportation management system. In particular embodiments, the transportation management system may receive the indication of the service need from a transportation management vehicle device placed in the vehicle (described in further detail below in reference to at least FIGS. 4A-4C), or the vehicle itself. For instance, the transportation management vehicle device may be connected to the vehicle via a vehicle interface, such as the CAN (Controller Area Network) interface, that allow an external computing system to communicate with, control, and configure the vehicle. Through the transportation management vehicle device and the CAN interface, for example, the transportation management system may send/receive data to/from the vehicle. In some embodiments, one or more of the CAN interface, a standalone fault/error-indicating device installed in the vehicle or other vehicle systems (e.g., infotainment, purchased or partner-provided systems, etc.) may send error codes or failure states relating to faults defined by the vehicle manufacturer to the transportation management system. Error codes may be aggregated from a variety of sources and reclassified in an onboard computing device of the vehicle and may be sent by the cars data connection to the transportation management system. The transportation management system may have stored responses for various error codes or failure states. Upon receiving an error code from the vehicle, the system may look up an appropriate response corresponding to the code and respond accordingly. Alternatively, the transportation management system may ping the transportation management vehicle device directly at period time intervals (e.g. every five minutes or every minute) or in real-time to get the current status of the vehicle including the indication of any service needs.

At step 304, the transportation management system may detect a service need that is required by the autonomous vehicle. In some embodiments, the transportation management system may receive performance statistics for various sensors/components of the vehicle indicating a current state of each sensor from the transportation management vehicle device installed in the vehicle. For instance, transportation management vehicle device may be connected to a central or main controlling unit of the vehicle (e.g., the engine control unit (ECU)) from which the device gets performance statistics for each sensor associated with the central or main controlling unit of the vehicle. The device then shares the performance statistics in real-time or at periodic time intervals with the transportation management system. Having received the performance statistics for each sensor, the transportation management system may compare the current statistics with the default/factory statistics for the sensor or the last known good configuration saved for that sensor. If the two statistics do not match or if the difference between the statistics are above a certain threshold, then the transportation management system may detect a service need that is required for an item/component that is associated with that particular sensor. By way of an example and without limitation, the transportation management system may receive performance statistics for an engine-temperature component indicating that the current engine temperature is about 230 Fahrenheit. An ideal engine temperature set in the default statistics for the same component is indicated to be within 180-220 Fahrenheit. Upon comparing the two, the transportation management system may detect that the engine of the autonomous vehicle is overheating, which calls for a major service need and may take an action for it accordingly (as discussed for example in reference to FIG. 3C). In some embodiments, the transportation management system may detect a service need based on a probabilistic approach, which compares a threshold value with known driving conditions relating to an error. For example, a vehicle driving up a mountain can be expected to cause some minor engine overheating and in this case, the system may not detect this as a service need required by the vehicle. If the vehicle exceeds a certain threshold value or range, then an error state may be triggered requesting for a service need.

As depicted in FIG. 3A, the transportation management system may detect the service need as one of 1) relating to an impaired/damaged sensor component 306 (e.g., in-vehicle GPS failure for directions), which may be detected through one or more of impaired functionality of the sensor component, data dissonance with other identical sensors with similar functionally as the impaired/damaged sensor component, operation outside of environmental tolerances, probabilistically due to age, or other factors, 2) a major service need 308 (e.g., tire change, radiator replacement due to engine overheat, etc.), 3) a minor or a common service need 310 (e.g., car wash, low washer fluid, gas refuel or battery recharge, etc.), 4) relating to regular car maintenance 312 (e.g., 10,000 miles service, yearly service, etc.), and 5) a panic situation or alert 314 from a passenger of the vehicle (e.g., passenger indicating that the vehicle is having some issues (vehicle making noise, air conditioning not working, smoke is coming out of the vehicle, etc.). It should be understood that the transportation management system is not limited to detecting and resolving the service needs 306-314 and other types of service needs are also possible and within the scope of the present disclosure.

FIG. 3B shows various steps performed by the transportation management system when the service need is related to a faulty/impaired sensor component 306. For example, the impaired sensor component may be a navigation-assistance component installed in the vehicle for navigating the vehicle to one or more locations. As another example, the impaired sensor component may be an objects-detection component (e.g., LiDAR, cameras) for detecting objects (e.g., cars, trees, speed breaker, rocks, people, etc.) around the vehicle. In some embodiments, responsive to detecting a faulty sensor/component in the first vehicle and depending on how major or big the fault, the transportation management system may take the first autonomous vehicle from a dispatch pool and set the status of the vehicle as temporarily non-operational for passenger pick-up and drop-off. At step 320, the transportation management system may determine whether the vehicle can safely drive further with the detected impaired sensor component. In some embodiments, the transportation management system may make this determination based on performance statistics/data indicating current state/condition of the vehicle received from the transportation management vehicle device or the vehicle itself (as discussed above). For instance, all sensors other than the impaired sensor may indicate that the vehicle is in a safe, drivable condition. For example, the only sensor component that is impaired may be the navigation-assistance component due to which the vehicle is unable to correctly identify the directions to a particular location, but all other sensors/components (e.g., LiDAR, cameras, etc.) may be working properly. As such, the system may determine that the vehicle can safely drive if provided with the right directions. As another example, the vehicle's LiDAR and/or cameras may be dirty, and consequently the vehicle's driving accuracy and/or safety may be compromised. In this case, the system may determine that the vehicle may continue to drive autonomously if it is provided with supplemental LiDAR/camera data. If in case the transportation management system determines in step 320 that the vehicle is not safe to drive, then at step 322, the system may send an instruction to the first autonomous vehicle to pull over at a nearest safe location and send a request to human road-side assistance (field agent) to arrive at the location of the vehicle and resolve the issue (e.g., by towing the impaired vehicle and taking it to a nearest service center location). Although not shown in FIG. 3B, if there are one or more ride requestors/passengers riding in the first vehicle, then the system may request an alternate autonomous vehicle or even to a ride provider (e.g., human-driven vehicle) to pick up the passengers from the location and transport them to their respective destinations.

If at step 320, the transportation management system determines that the vehicle can still safely drive with the impaired sensor component, then at step 323, the transportation management system may identify a sensor type of the impaired sensor component. For instance, a sensor component may comprise of one or more sensor types and an impaired sensor component may have a particular sensor type that may be faulty or not working properly. By way of an example, the sensor component may be a GPS module comprising of a traffic sensor for analyzing current traffic conditions, a speed-limit sensor for determining speed limit in the current geographic area/region of the vehicle, accidents or hazards sensor for identifying any accidents or potential hazards (e.g., road work, construction, etc.) in the current route of the vehicle, etc. In this example, the GPS module may have a faulty traffic sensor due to which it may be unable to properly analyze the current traffic conditions, which may lead to delay in transmit or commute time. At step 324, the transportation management system may identify a second autonomous vehicle (Shepherd autonomous vehicle) having all functional sensors including their respective sensor types. The transportation management system may identify this second vehicle by first identifying one or more vacant autonomous vehicles (i.e., vehicle carrying no passengers) that are located in the vicinity or within a certain threshold distance of the current geographic location of the first autonomous vehicle. For example, the system may identify if there is a vacant autonomous vehicle located within five miles from the current location of the impaired first vehicle. If the system identifies one, then it may send instruction to the identified second autonomous vehicle to drive to the location of the first autonomous vehicle. If in case the system does not identify an available autonomous vehicle in the vicinity or within the certain threshold distance from the first vehicle, then the system may request a second autonomous vehicle from a dispatch pool (e.g., main central location where the fleet of all the autonomous vehicles are located). While the second autonomous vehicle arrives at the location of the first vehicle, the first autonomous vehicle may be instructed by the transportation management system to pull over and wait at a nearest safe location. In particular embodiments, transportation management system may take the identified second autonomous vehicle from the dispatch pool and set its status as temporarily non-operational for passenger pick-up and drop-off (i.e., the identified second vehicle may not take and fulfill any new ride requests). At step 326, the system may determine a suitable service center location where the first autonomous vehicle can be directed for repair. In particular embodiments, the system my determine a service center based on one or more criteria. The one or more criteria may include, as an example and without limitation, proximity of a service center location to the current geographic location of the first vehicle, specialty or expertise of a service center in fixing that particular impaired sensor component, user ratings/feedback associated with a service center, cost-effectiveness in repairing the impaired sensor component, availability of a service center (i.e., how soon the service center can begin working on the repair), estimate time for the repair, etc.

At step 328, the transportation management system may instruct the identified second autonomous vehicle (Shepherd vehicle) to share its sensor data with the first autonomous vehicle (see for example, FIG. 1A) and/or lead the first autonomous vehicle (see for example, FIG. 1B) to the service center location. For instance, as discussed above, the impaired sensor component or the sensor type of the impaired sensor component in the first autonomous vehicle may be the objects-detection component (e.g., LiDAR) due to which the vehicle is not able to properly identify objects surrounding the vehicle. The second autonomous vehicle may be instructed to drive close to the impaired vehicle, sense the surroundings using its functional sensor component, and share its sensing or sensor data with the first autonomous vehicle. In some embodiments, the second autonomous vehicle may share raw sensor data (e.g., data that has not been modified, altered, or edited). Raw data sharing means that the second autonomous vehicle may share all the data provided by its sensor(s). In some embodiments, the second autonomous vehicle may provide processed sensor data, which may include more concentrated data or data specific to the requirement/service need of the first autonomous vehicle (e.g., data comprising detected objects, computed speed limits, known turn restrictions, stop light state, etc.). In some embodiments, the second autonomous vehicle may drive in front of the first vehicle to sense the environment and share its sensing with the first vehicle. In order to successfully share sensor data and/or for the sensor data to be relevant to the first vehicle, the second autonomous vehicle may need to be located within a predefined distance from the first autonomous vehicle. In some embodiments, the second vehicle may share the sensor data directly with the first vehicle via one or more wireless communication channels (e.g., Bluetooth, infrared, etc.). In some embodiments, the second autonomous vehicle may share its sensor data with the first vehicle via the transportation management system. For instance, the second vehicle may first send the sensor data to the transportation management system, which then sends the data to the first autonomous vehicle along with instructions to perform an action, as discussed with respect to step 330 below. In some embodiments, the second autonomous vehicle (Shepherd vehicle) may provide direct or indirect shepherding to the first autonomous vehicle (impaired vehicle). In the direct shepherding, the impaired vehicle may target its remaining sensor on the shepherd car and follow it closely (ignoring everything else). In the indirect shepherding, the shepherd vehicle may share its sensor data with the impaired vehicle via vehicle-to-vehicle communications so that the impaired vehicle may have complete situational awareness in spite of a compromised sensor or sensors. The difference between direct and indirect shepherding is that in the latter case the impaired vehicle may still make decisions independently.

At step 330, the transportation management system may instruct the first autonomous vehicle to drive to the determined service center location using the sensor data from the second autonomous vehicle (see for example, FIG. 1A) and/or follow the second vehicle (see for example, FIG. 1B) to the service center location. For instance, as discussed above, the second autonomous vehicle may drive in front of the first vehicle and share its sensor data of the surrounding environment and/or objects with the first vehicle. The first vehicle may use such sensor data from the second vehicle and its own sensor data to make autonomous driving decisions. Additionally or alternatively, the system may instruct the first autonomous vehicle to follow the second vehicle to the service center location. For instance, the first autonomous vehicle may simply lock-onto the second autonomous vehicle and enter a new mode of autonomy where the objective is simply to follow the second autonomous vehicle (e.g., driving directly behind the second autonomous vehicle), trusting it to drive safely. Furthermore, the system may instruct the second autonomous vehicle to drive to the service center location with the first autonomous vehicle. At step 332, the system may receive an indication at some point that the first vehicle has reached the service center location. For instance, current location information (e.g., geolocation) may be constantly transmitted by the vehicle to the system or the system may directly query the vehicle for its geolocation at periodic time intervals or in real-time. Having received the indication that the first vehicle has reached the service center for repair, at step 334, the system send an instruction to the second autonomous vehicle to return to its normal operation of transporting passengers to their respective destinations. At this point, the system may put the second autonomous vehicle back to the dispatch pool indicating that the vehicle is operational for passenger transportation purposes.

In some embodiments, although not shown in FIG. 3B, if there is a passenger in the first autonomous vehicle (with the impaired sensor component) and the system determines in step 320 that the vehicle can safely drive, then the system may instruct the second autonomous vehicle to first lead the first vehicle to the passenger's destination and drop-off the passenger prior to going to the service center. For instance, after the system has identified the second autonomous vehicle in step 324, the system may obtain the passenger's destination location from the first vehicle or from the passenger's computing device (e.g., a transportation application running on a mobile device of the passenger) and share the passenger's destination location information with the second autonomous vehicle. The system may instruct the second autonomous vehicle to share its sensor data with first vehicle and/or lead the first vehicle to the passenger destination. The system may also send an instruction to the first autonomous vehicle to drive to the passenger's destination location using the sensor data from the second vehicle and/or follow the second vehicle to the destination. Once the system receives an indication from either the first vehicle or the second vehicle that the passenger has been dropped-off at his location, the system may perform the steps 326-334 as discussed elsewhere herein.

FIG. 3C shows various steps performed by the transportation management system when the service need is a major service need 308. As an example and not by way of limitation, a major service need may be relating to vehicle's engine overheating that calls for one of the vehicle's water pump replacement, radiator repair or replacement, coolant flush, thermostat replacement, engine oil top-up or change, or coolant hose replacement. As another example, a major service may be relating to a deflated or flat tire that calls for a field agent to arrive at the current geographic location of the vehicle and replace the tire. At step 336, the transportation management system determines if the first vehicle requiring major service need is carrying one or more ride requestors or passengers in the vehicle. If the determination is affirmative, then at step 338, the system requests a next available second autonomous vehicle located in the vicinity or within a certain threshold distance of the first vehicle to pick the one or more passengers and transport them to their respective destinations. If the system determines in step 336 that the first vehicle is not carrying any passengers or after requesting a second autonomous vehicle for the passenger(s) for transporting to respective destinations, the system make a determination at step 340 of whether the first vehicle is in a condition to further drive. The system may make this determination as discussed with respect to step 320 in FIG. 3B. If in case the transportation management system determines in step 340 that the first vehicle cannot drive further or is stuck, then at step 342, the system may send a request to human road-side assistance (field agent) to arrive at the current geographic location of the vehicle and take an action with respect to the first vehicle. For example, the system may determine in step 340 that the first vehicle cannot drive further because it has a flat tire. Based on this determination, the system may request a field agent to go to the location of the vehicle and replace the flat tire.

If the transportation management system determines in step 340 that the first vehicle can further drive, then in step 344, the system may request performance data from the first vehicle indicating current state/condition of the vehicle. For instance, the system may request performance statistics for the various sensors (e.g., engine sensors, cameras, microphones, infrared, sonars, LiDARs, lightening, temperature, weather, and any other suitable sensors etc.) in the first vehicle from the transportation management vehicle device, as discussed elsewhere herein. In response to the request, in step 346, the system may receive the performance data/statistics from the first autonomous vehicle and then in step 348, the system may determine how far the first vehicle can drive based on the current state/condition of the vehicle. By way of an example, as discussed above, the major service need may be relating to an engine overheating issue and the performance data received from the first vehicle indicates that the engine-temperature sensor specifies a current engine temperature of 200 Fahrenheit. Based on this current temperature reading and history of previous temperature readings (e.g., readings in last fifteen minutes), the system may estimate that the vehicle can drive up to an additional 10 miles before the temperature rises to the engine temperature of 220 Fahrenheit, which may be the threshold temperature limit beyond which the engine would probably cease operating. Having determined a total distance that the first autonomous vehicle can drive, the system may identify, in step 350, one or more service centers that are located within this total distance. Taking the example above where the system estimated that the first vehicle can drive up to an additional 10 miles, the system may identify one or more service centers that are located within 10 miles from the current location of the first vehicle. The system may identify the service centers based on the one or more criteria as discussed with respect to step 326 in FIG. 3B. In particular embodiments, the system may identify three types of service centers, such as a nearest service center (e.g., for vehicle with urgent and/or major service need), a specialty service center (e.g., for a particular type of service required by the vehicle for which a given service center specializes in), or a best service center (e.g., service center with high user rating/feedback and most cost-efficient for service repairs). In particular embodiments, the system may identify a nearest service center based on determining current geographic location of the first autonomous vehicle, identifying one or more service centers that are located in the vicinity of the current geographic location or within a particular threshold distance (e.g., 2 miles) from the vehicle, and identifying a service center that is nearest or takes the least amount of time for the vehicle to reach. The system may identify a specialty service center by accessing a database or query for service centers that offer particular or specialized services. The system may identify a best service center by accessing a service review database and/or a record of the quality-of-service of various service centers, and identifying the one that has the best reviews and/or quality of service.

At step 352, a determination may be made that whether the system identified one or more service centers within the total distance (e.g., 10 miles). If the result of the determination is negative, then the transportation management system may instruct the first autonomous vehicle to pull over at a nearest safe location and send a request to human road-side assistance (field agent) to arrive at the location of the vehicle and resolve the issue (e.g., by towing the impaired vehicle and taking it to a nearest service center location). Otherwise if the system does identify the one or more service centers, then in step 354, the system determines whether the first vehicle requires a particular type of service. For example, in order to the fix/repair the major service need of the first vehicle, a particular type of component need to be replaced that is available at only select specialty service center locations. If that's the case then in step 356, the system may send driving directions to a specialty service center located within the total distance and instructs the vehicle to go to specialty service center location using the driving directions. The specialty service center may specialize in the particular type of service required by the vehicle. If otherwise the system determines that the particular or special service is not required then in step 358, the system may send driving directions to a nearest service center (i.e., one located nearest to the current location of the first autonomous vehicle) and instructs the vehicle to go to nearest service center location using the driving directions. It should be realized that a best service center may not be applicable for a major service need because of the urgency of the service required by the vehicle. A best service center is well suited for vehicles with minor service needs as discussed in further detail below in reference to FIG. 3D.

FIG. 3D shows various steps performed by the transportation management system when the service need is a minor or common service need 310. As an example and not by way of limitation, a minor or common service need may be oil change, windshield washer fluid refill, car wash, gas refill, battery recharge for electric-type vehicle, inside car vacuum, or any other service need that, if not addressed immediately, would not impact the vehicle's current operation. At step 359, the transportation management system determines if the first vehicle requiring minor service need is carrying one or more passengers in the vehicle. If the determination is affirmative, then at step 360, the system may instruct the first autonomous vehicle to first drop-off the one or more passengers at their respective destination locations. For instance, a minor service need is classified by the system as not an immediate or urgent need that would impact the current operation of the vehicle, and as such it is a need that can wait to be addressed. When processing this need, the system may prioritize handling its current passenger needs before addressing the minor service need. Therefore, if the system determines that there is a passenger currently riding in the vehicle then the system may instruct the vehicle to first fulfill the passenger request (e.g., dropping-off at a particular location), and once the request is fulfilled then identify a service center to fulfill the minor service need of the vehicle. In a situation when the system determines there are no passengers presently riding in the vehicle, the system may first process the minor need before taking any new ride requests.

At step 362, the transportation management system may receive an indication that the one or more passengers have been dropped-off at their respective destinations. In some embodiments, the system may receive this indication from a ride requestor's/passenger's computing device (e.g., a transportation application running on a mobile device of the passenger) that the passenger has reached his destination. In other embodiments, current location information (e.g., geolocation) may be constantly transmitted by the vehicle to the system or the system may directly query the vehicle for its geolocation at periodic time intervals or in real-time to get this indication. Once the one or more passengers have been dropped-off, at step 364, the system may identify a best service center for navigating the vehicle to its respective service location for resolving the minor service need. The best service center may be identified based on one or more criteria, including for example, user ratings and/or comments associated with a service center (e.g., service center 1 is given 4.5/5 star rating by users and 100 reviews while service center 2 is given only 3/5 star rating and 57 reviews), proximity of a service center to the current geographic location of the first vehicle (i.e., how close the service center is located which itself lead to fuel saving), cost effectiveness of a service center (e.g., repairs or service components at service center X may cost less than at service center Y), etc. As discussed earlier, a best service center may be best suited for situations where a vehicle can still drive long distances and have less urgent, minor, or common service needs. In response to identifying a best service center, at step 366, the system may send driving directions to the best service center location and instructs the vehicle to go to the best service center location using the driving directions.

FIG. 3E shows various steps performed by the transportation management system when the service need is relating to a regular car maintenance 312. As an example and not by way of limitation, the regular car maintenance may be a 10,000 miles service or a 1 year maintenance service and the service need may be scheduling for this maintenance at a service center location. In step 368, the transportation management system may identify the maintenance required by the first vehicle based on prior vehicle maintenance data, current state of the first vehicle, and/or according to a machine-learning model. For example, the prior vehicle maintenance data may indicate that a 20,000 miles service was performed about an year ago and the vehicle is scheduled for its next service when it reaches 30,000 miles. As another example, a machine-learning model may be trained using a plurality of vehicle maintenance service histories from which the model knows that a vehicle is generally scheduled for its regular maintenance on at-least an year-by-year basis or in every 10,000 miles. The machine-learning model may use the current state/condition/statistics of the first vehicle and prior vehicle maintenance data to automatically identify if the first vehicle is due for its maintenance and type of maintenance that is due for the vehicle. For example, the current statistics of the first vehicle may indicate that the vehicle has 19,500 miles and the prior vehicle maintenance data indicate that the last maintenance was performed when the vehicle had 9,754 miles. In this example, the machine-learning may identify that the vehicle will be due for its 20,000 miles service in another 254 miles.

Having identified the required maintenance, the transportation management system may make a determination of whether the maintenance is overdue (step 370) or upcoming (step 378). Continuing with the machine-learning model maintenance example above where the vehicle has currently 19,500 miles and last maintenance was performed at 9,754 miles, the system may determine in this case that the maintenance is upcoming in 254 miles. If in case the vehicle was instead identified as having 21,000 miles then the system may determine that the maintenance for the vehicle is overdue. If the system determines in step 370 that the maintenance is overdue, then in step 371, the system determines if the first vehicle requiring maintenance is carrying one or more ride requestors/passengers in the vehicle. If the determination is affirmative, then at step 372, the system may instruct the first autonomous vehicle to first drop-off the one or more passengers at their respective destination locations and at step 373, the system may receive an indication that the one or more passengers have been dropped-off at their respective destinations, as discussed with respect to steps 360 and 362 in FIG. 3D. In response to receiving the indication, at step 374, the system may take out the first vehicle from the dispatch pool and mark its status as non-operational for use (e.g., not available for passenger pick-up and drop-off or to take any new ride requests). At step 376, the system may identify a nearest service center location or a specialty service center location if a particular type of service is required by the vehicle. As an example, the first vehicle may be due for a particular part replacement and the system may identify a service center that specializes in providing that part. It should be understood that a best service center case scenario may not be suited here since the first vehicle is already overdue for its required maintenance. The aim of the system in this case is to get the first vehicle to a next available and nearest service center as soon as possible before the vehicle run into any issues. At step 377, the system may schedule the identified nearest service center or the specialty service center for the identified maintenance. In some embodiments, responsive to scheduling the identified service center, the system may send instructions to the first vehicle, the instructions including the navigation directions to the service center location and date/time to arrive at the identified center.

If the transportation management system determines that the maintenance is not overdue but its upcoming (step 378), then at step 380, the system determines if the first vehicle requires a particular maintenance. If so, then at step 382, the system schedules a specialty service center for maintenance, as discussed elsewhere herein. Otherwise, at step 384, the system identify a best service center for maintenance since the maintenance is not due immediate and thus the vehicle can be sent to a service center with high rating, positive feedback, and one which is cost effective and time efficient. The best service center may be identified based on one or more criteria as discussed with respect to step 364 in FIG. 3D. At step 386, the system may schedule the identified best service center for the identified maintenance. In some embodiments, responsive to scheduling the identified service center, the system may send instructions to the first vehicle, the instructions including the navigation directions to the service center location and date/time to arrive at the identified center. If in case the transportation management system determines the maintenance as neither overdue (in step 370) nor upcoming (in step 378), then at step 388, the system determines that the maintenance is not required at this point and may check for the same at a later time.

FIG. 3F shows various steps performed by the transportation management system when the service need is relating to a panic alert 312 received from the ride requestor or passenger of the first autonomous vehicle. The system may receive the alert from passenger's computing device (e.g., a transportation application (app) running on a mobile device of the passenger). As an example and not by way of limitation, the passenger may use the app to indicate to the system that the first vehicle is having some issues, such as vehicle making noise, vehicle has a flat tire, air conditioning not working, etc. At step 390, the system may analyze the panic alert received from the passenger and determines whether the alert relates to stopping the first vehicle (step 392), requesting an alternate vehicle (step 394), passenger indicating that the first vehicle requires a major service need (step 396), or the passenger indicating that the first vehicle requires a minor service need (step 398). It should be understood that the alerts 392-398 are provided here just for exemplary purposes and the present disclosure is not limited by any means to responding to only these alerts 392-398, and that various other kinds of alerts are contemplated and are within the scope of the present disclosure.

At step 392, if the system determines that the passenger panic alert relates to stopping the first vehicle, then at step 393, the system may send an instruction to the first autonomous vehicle to pull over at a nearest safe location and wait until provided with another instruction. For example, the first vehicle may be making some weird noise and shaking due to which the passenger of the vehicle panics and requests to stop the vehicle. In response to stopping the first vehicle or if the panic alert does not relate to stopping the vehicle, at step 394, the system determines if the passenger wants an alternate vehicle to get to their destination. If so, at step 395, the system may send a request to a second autonomous vehicle to pick up the passenger from a current geographic location of the first vehicle and transport the passenger to their respective destination. At step 396, the system determines if the panic alert relates to passenger indicating that the first vehicle requires a major service need, as discussed above in detail in reference to FIG. 3C. If so, then the system may proceed to perform step 336 and subsequent steps thereon with respect to the major service need (see FIG. 3C). Otherwise, at step 398, the system determines if the panic alert relates to passenger indicating that the first vehicle requires a minor or a common service need, as discussed above in detail in reference to FIG. 3D. If so, then the system may proceed to perform step 359 and subsequent steps thereon with respect to the minor service need (see FIG. 3D). If in case, the result of the determination in each of the steps 392-398 is negative, then at step 399, the system may send a message to the passenger's computing device (e.g., on the transportation app running on the passenger's mobile device) confirming if the passenger is having any issues with vehicle. The passenger may send his response (e.g., by selecting a predefined option or via text) and the system may take an action accordingly.

Particular embodiments may repeat one or more steps of the method 300 of FIGS. 3A-3F, where appropriate. Although this disclosure describes and illustrates particular steps of the method of FIGS. 3A-3F as occurring in a particular order, this disclosure contemplates any suitable steps of the method of FIGS. 3A-3F occurring in any suitable order. Moreover, although this disclosure describes and illustrates an example method for providing responses to service needs of an impaired autonomous vehicle, including the particular steps of the method of FIGS. 3A-3F, this disclosure contemplates any suitable method for providing responses to service needs of an impaired autonomous vehicle, including any suitable steps, which may include all, some, or none of the steps of the method of FIGS. 3A-3F, where appropriate. Furthermore, although this disclosure describes and illustrates particular components, devices, or systems carrying out particular steps of the method of FIGS. 3A-3F, this disclosure contemplates any suitable combination of any suitable components, devices, or systems carrying out any suitable steps of the method of FIGS. 3A-3F. For example, while the steps in FIGS. 3A-3F may be performed by the transportation management system, any combination of those steps may be performed by any other computing system, including, e.g., the ride requestor's computing device, the transportation management vehicle device, and/or the vehicle.

FIGS. 4A-4C show an example transportation management vehicle device 460 in accordance with embodiments described herein. The transportation management vehicle device 460 may include a front view 402 (FIG. 4A) and a rear view 408 (FIG. 4B). In particular embodiments, the front view 402 may be designed to face the outside of the vehicle so that it is visible to, e.g., ride requestors, and the rear view 408 may be designed to face the interior of the vehicle so that it is visible to, e.g., the passengers. As shown in FIG. 4A, a front view 402 of the transportation management vehicle device 460 may include a front display 404. In particular embodiments, the front display 404 may include a secondary region or separate display 406. As shown in FIG. 4A, the front display 404 may include various display technologies including, but not limited to, one or more liquid crystal displays (LCDs), one or more arrays of light emitting diodes (LEDs), AMOLED, or other display technologies. In particular embodiments, the front display 404 may include a cover that divides the display into multiple regions. In particular embodiments, separate displays may be associated with each region. In particular embodiments, the front display 404 may be configured to show colors, text, animation, patterns, color patterns, or other identifying information to requestors and other users external to a provider vehicle (e.g., at a popular pick-up location, requestors may quickly identify their respective rides and disregard the rest based on the identify information shown). In particular embodiments, the secondary region or separate display 406 may be configured to display the same, or contrasting, information as front display 404.

FIG. 4B shows an embodiment of the rear view 408 of the transportation management vehicle device 460. As shown, the rear view 408 in particular embodiments may include a rear display 410. As with the front display 404, the rear display 410 may include various display technologies including, but not limited to, one or more liquid crystal displays (LCDs), one or more arrays of light emitting diodes (LEDs), AMOLED, or other display technologies. The rear display 480 may be configured to display information to the provider, the requestor, or other passengers in the passenger compartment of the vehicle. In particular embodiments, rear display 410 may be configured to provide information to people who are external to and behind the provider vehicle. Information may be conveyed via, e.g., scrolling text, color, patterns, animation, and any other visual display. As further shown in FIG. 4B, the transportation management vehicle device 460 may include a power button 412 or other user interface which can be used to turn the device 460 on or off. In particular embodiments, power button 412 may be a hardware button or switch that physically controls whether power is provided to the transportation management vehicle device 460. Alternatively, power button 412 may be a soft button that initiates a startup/shutdown procedure managed by software and/or firmware instructions. In particular embodiments, the transportation management vehicle device 460 may not include a power button 412. Additionally, the transportation management vehicle device 460 may include one or more light features 414 (such as one or more LEDs or other light sources) configured to illuminate areas adjacent to the device 460 and/or provide status signals.

In particular embodiments, the transportation management vehicle device 460 may include a connector 416. In particular embodiments, the connector 416 may be configured to physically connect to the ride provider's computing device and/or the requestor's computing device. In particular embodiments, the connector 416 may be configured for physically connecting the transportation management vehicle device 460 to the vehicle for power and/or for communicating with the vehicle. For instance, the connector 416 may implement a suitable communication interface or protocol for communicating with the vehicle. For example, through the connector 416, the transportation management vehicle device 460 may be able to issue instructions to the vehicle's onboard computer and cause it to adjust certain vehicle configurations, such as air-conditioning level, entertainment/informational content (e.g., music, news station, content source, etc.), audio volume, window configuration, seat warmer temperature, and any other configurable features of the vehicle. As another example, the connector 416 may enable the transportation management vehicle device 460 to query the vehicle for certain data, such as current configurations of any of the aforementioned features, as well as the vehicle's speed, fuel level, tire pressure, external temperature gauge, navigation system, and any other information available through the vehicle's computing system. In particular embodiments, the transportation management vehicle device 460 may be further configured with wireless communication capabilities (e.g., Bluetooth, WI-FI, NFC, etc.), thereby enabling the device 460 to wirelessly communicate with the vehicle, the provider's computing device, and/or the requestor's computing device.

In particular embodiments, the transportation management vehicle device 460 may be integrated with one or more sensors 419, such as a camera, microphone, infrared sensor, gyroscope, accelerometer, and any other suitable sensor for detecting signals of interest within the passenger compartment of the vehicle. For example, the sensor 419 may be a rear-facing wide-angle camera that captures the passenger compartment and any passengers therein. As another example, the sensor 419 may be a microphone that captures conversation and/or sounds in the passenger compartment. The sensor 419 may also be an infrared sensor capable of detecting motion and/or temperature of the passengers.

Although FIG. 4B illustrates particular numbers of components (e.g., a single sensor 419, a single display 410, a single connector 416, etc.), one of ordinary skill in the art would appreciate that any suitable number of each type of component may be included in the transportation management vehicle device 460. For example, in particular embodiments, a transportation management vehicle device 460 may include one or more of a camera, microphone, and infrared sensor. As another example, the device 460 may include one or more communication interfaces, whether wired or wireless.

FIG. 4C shows a block diagram of various components of a transportation management vehicle device 460 in accordance with particular embodiments. As shown in FIG. 4C, the transportation management vehicle device 460 may include a processor 418. Processor 418 may control information displayed on rear display 410 and front display 404. As described herein, each display may be designed to display information to different intended users, depending on the positioning of the users and the transportation management vehicle device 460. In particular embodiments, display data 420 may include stored display patterns, sequences, colors, text, animation or other data to be displayed on the front and/or rear display. The display data 420 may also include algorithms for generating content and controlling how it is displayed. The generated content, for example, may be personalized based on information received from the transportation management system, any third-party system, the vehicle, and the computing devices of the provider and/or requestor. In particular embodiments, display data 420 may be stored in a hard disk drive, solid state drive, memory, or other storage device.

In particular embodiments, lighting controller 422 may manage the colors and/or other lighting displayed by light features 414, the front display 404, and/or the back display 410. The lighting controller may include rules and algorithms for controlling the lighting features 414 so that the intended information is conveyed. For example, to help a set of matching provider and requestor find each other at a pick-up location, the lighting controller 422 may obtain instructions that the color blue is to be used for identification. In response, the front display 404 may display blue and the lighting controller 422 may cause the light features 414 to display blue so that the ride provider would know what color to look for.

In particular embodiments, the transportation management vehicle device 460 may include a communication component 424 for managing communications with other systems, including, e.g., the provider device, the requestor device, the vehicle, the transportation management system, and third-party systems (e.g., music, entertainment, traffic, and/or maps providers). In particular embodiments, communication component 424 may be configured to communicate over WI-FI, Bluetooth, NFC, RF, or any other wired or wireless communication network or protocol.

In particular embodiments, the transportation management vehicle 460 may include an input/output system 426 configured to receive inputs from users and/or the environment and provide output. For example, I/O system 426 may include a sensor such as an image-capturing device configured to recognize motion or gesture-based inputs from passengers, a microphone configured to detect and record speech or dialog uttered, a heat sensor to detect the temperature in the passenger compartment, and any other suitable sensor. The I/O system 426 may output the detected sensor data to any other system, including the transportation management system, the computing devices of the ride provider and requestor, etc. Additionally, I/O system 426 may include audio device configured to provide audio outputs (such as alerts, instructions, or other information) to users and/or receive audio inputs, such as audio commands, which may be interpreted by a voice recognition system or other command interface. In particular embodiments, I/O system 426 may include one or more input or output ports, such as USB (universal serial bus) ports, lightning connector ports, or other ports enabling users to directly connect their devices to the transportation management vehicle device 460 (e.g., to exchange data, verify identity information, provide power, etc.).

FIG. 5 illustrates an example block diagram of a transportation management environment for matching ride requestors with autonomous vehicles. In particular embodiments, the environment may include various computing entities, such as a user computing device 530 of a user 501 (e.g., a ride provider or requestor), a transportation management system 560, an autonomous vehicle 540, and one or more third-party system 570. The computing entities may be communicatively connected over any suitable network 510. As an example and not by way of limitation, one or more portions of network 510 may include an ad hoc network, an extranet, a virtual private network (VPN), a local area network (LAN), a wireless LAN (WLAN), a wide area network (WAN), a wireless WAN (WWAN), a metropolitan area network (MAN), a portion of the Internet, a portion of Public Switched Telephone Network (PSTN), a cellular network, or a combination of any of the above. In particular embodiments, any suitable network arrangement and protocol enabling the computing entities to communicate with each other may be used. Although FIG. 5 illustrates a single user device 530, a single transportation management system 560, a single vehicles 540, a plurality of third-party systems 570, and a single network 510, this disclosure contemplates any suitable number of each of these entities. As an example and not by way of limitation, the network environment may include multiple users 501, user devices 530, transportation management systems 560, autonomous-vehicles 540, third-party systems 570, and networks 510.

The user device 530, transportation management system 560, autonomous vehicle 540, and third-party system 570 may be communicatively connected or co-located with each other in whole or in part. These computing entities may communicate via different transmission technologies and network types. For example, the user device 530 and the vehicle 540 may communicate with each other via a cable or short-range wireless communication (e.g., Bluetooth, NFC, WI-FI, etc.), and together they may be connected to the Internet via a cellular network accessible to either one of the devices (e.g., the user device 530 may be a smartphone with LTE connection). The transportation management system 560 and third-party system 570, on the other hand, may be connected to the Internet via their respective LAN/WLAN networks and Internet Service Providers (ISP). FIG. 5 illustrates transmission links 550 that connect user device 530, autonomous vehicle 540, transportation management system 560, and third-party system 570 to communication network 510. This disclosure contemplates any suitable transmission links 550, including, e.g., wire connections (e.g., USB, Lightning, Digital Subscriber Line (DSL) or Data Over Cable Service Interface Specification (DOCSIS)), wireless connections (e.g., WI-FI, WiMAX, cellular, satellite, NFC, Bluetooth), optical connections (e.g., Synchronous Optical Networking (SONET), Synchronous Digital Hierarchy (SDH)), any other wireless communication technologies, and any combination thereof. In particular embodiments, one or more links 550 may connect to one or more networks 510, which may include in part, e.g., ad hoc network, the Intranet, extranet, VPN, LAN, WLAN, WAN, WWAN, MAN, PSTN, a cellular network, a satellite network, or any combination thereof. The computing entities need not necessarily use the same type of transmission link 550. For example, the user device 530 may communicate with the transportation management system via a cellular network and the Internet, but communicate with the autonomous vehicle 540 via Bluetooth or a physical wire connection.

In particular embodiments, the transportation management system 560 may fulfill ride requests for one or more users 501 by dispatching suitable vehicles. The transportation management system 560 may receive any number of ride requests from any number of ride requestors 501. In particular embodiments, a ride request from a ride requestor 501 may include an identifier that identifies them in the system 560. The transportation management system 560 may use the identifier to access and store the ride requestor's 501 information, in accordance with his/her privacy settings. The ride requestor's 501 information may be stored in one or more data stores (e.g., a relational database system) associated with and accessible to the transportation management system 560. In particular embodiments, ride requestor information may include profile information about a particular ride requestor 501. In particular embodiments, the ride requestor 501 may be associated with one or more categories or types, through which the ride requestor 501 may be associated with aggregate information about certain ride requestors of those categories or types. Ride information may include, for example, preferred pick-up and drop-off locations, driving preferences (e.g., safety comfort level, preferred speed, rates of acceleration/deceleration, safety distance from other vehicles when travelling at various speeds, route, etc.), entertainment preferences and settings (e.g., preferred music genre or playlist, audio volume, display brightness, etc.), temperature settings, whether conversation with the driver is welcomed, frequent destinations, historical riding patterns (e.g., time of day of travel, starting and ending locations, etc.), preferred language, age, gender, or any other suitable information. In particular embodiments, the transportation management system 560 may classify a user 501 based on known information about the user 501 (e.g., using machine-learning classifiers), and use the classification to retrieve relevant aggregate information associated with that class. For example, the system 560 may classify a user 501 as a teenager and retrieve relevant aggregate information associated with teenagers, such as the type of music generally preferred by teenagers.

Transportation management system 560 may also store and access ride information. Ride information may include locations related to the ride, traffic data, route options, optimal pick-up or drop-off locations for the ride, or any other suitable information associated with a ride. As an example and not by way of limitation, when the transportation management system 560 receives a request to travel from San Francisco International Airport (SFO) to Palo Alto, Calif., the system 560 may access or generate any relevant ride information for this particular ride request. The ride information may include, for example, preferred pick-up locations at SFO; alternate pick-up locations in the event that a pick-up location is incompatible with the ride requestor (e.g., the ride requestor may be disabled and cannot access the pick-up location) or the pick-up location is otherwise unavailable due to construction, traffic congestion, changes in pick-up/drop-off rules, or any other reason; one or more routes to navigate from SFO to Palo Alto; preferred off-ramps for a type of user; or any other suitable information associated with the ride. In particular embodiments, portions of the ride information may be based on historical data associated with historical rides facilitated by the system 560. For example, historical data may include aggregate information generated based on past ride information, which may include any ride information described herein and telemetry data collected by sensors in autonomous vehicles and/or user devices. Historical data may be associated with a particular user (e.g., that particular user's preferences, common routes, etc.), a category/class of users (e.g., based on demographics), and/or all users of the system 560. For example, historical data specific to a single user may include information about past rides that particular user has taken, including the locations at which the user is picked up and dropped off, music the user likes to listen to, traffic information associated with the rides, time of the day the user most often rides, and any other suitable information specific to the user. As another example, historical data associated with a category/class of users may include, e.g., common or popular ride preferences of users in that category/class, such as teenagers preferring pop music, ride requestors who frequently commute to the financial district may prefer to listen to news, etc. As yet another example, historical data associated with all users may include general usage trends, such as traffic and ride patterns. Using historical data, the system 560 in particular embodiments may predict and provide ride suggestions in response to a ride request. In particular embodiments, the system 560 may use machine-learning, such as neural-networks, regression algorithms, instance-based algorithms (e.g., k-Nearest Neighbor), decision-tree algorithms, Bayesian algorithms, clustering algorithms, association-rule-learning algorithms, deep-learning algorithms, dimensionality-reduction algorithms, ensemble algorithms, and any other suitable machine-learning algorithms known to persons of ordinary skill in the art. The machine-learning models may be trained using any suitable training algorithm, including supervised learning based on labeled training data, unsupervised learning based on unlabeled training data, and/or semi-supervised learning based on a mixture of labeled and unlabeled training data.

In particular embodiments, transportation management system 560 may include one or more servers. Each server may be a unitary server or a distributed server spanning multiple computers or multiple datacenters. The servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, transportation management system 560 may include one or more data stores. The data stores may be used to store various types of information, such as ride information, ride requestor information, ride provider information, historical information, third-party information, or any other suitable type of information. In particular embodiments, the information stored in the data stores may be organized according to specific data structures. In particular embodiments, each data store may be a relational, columnar, correlation, or other suitable database system. Although this disclosure describes or illustrates particular types of databases, this disclosure contemplates any suitable types of databases. Particular embodiments may provide interfaces that enable a user device 530 (which may belong to a ride requestor or provider), a transportation management system 560, vehicle system 540, or a third-party system 570 to process, transform, manage, retrieve, modify, add, or delete the information stored in data store.

In particular embodiments, transportation management system 560 may include an authorization server (or other suitable component(s)) that allows users 501 to opt-in to or opt-out of having their information and actions logged, recorded, or sensed by transportation management system 560 or shared with other systems (e.g., third-party systems 570). In particular embodiments, a user 501 may opt-in or opt-out by setting appropriate privacy settings. A privacy setting of a user may determine what information associated with the user may be logged, how information associated with the user may be logged, when information associated with the user may be logged, who may log information associated with the user, whom information associated with the user may be shared with, and for what purposes information associated with the user may be logged or shared. Authorization servers may be used to enforce one or more privacy settings of the users 501 of transportation management system 560 through blocking, data hashing, anonymization, or other suitable techniques as appropriate.

In particular embodiments, third-party system 570 may be a network-addressable computing system that may host GPS maps, customer reviews, music or content, weather information, or any other suitable type of information. Third-party system 570 may generate, store, receive, and send relevant data, such as, for example, map data, customer review data from a customer review website, weather data, or any other suitable type of data. Third-party system 570 may be accessed by the other computing entities of the network environment either directly or via network 510. For example, user device 530 may access the third-party system 570 via network 510, or via transportation management system 560. In the latter case, if credentials are required to access the third-party system 570, the user 501 may provide such information to the transportation management system 560, which may serve as a proxy for accessing content from the third-party system 570.

In particular embodiments, user device 530 may be a mobile computing device such as a smartphone, tablet computer, or laptop computer. User device 530 may include one or more processors (e.g., CPU and/or GPU), memory, and storage. An operation system and applications may be installed on the user device 530, such as, e.g., a transportation application associated with the transportation management system 560, applications associated with third-party systems 570, and applications associated with the operating system. User device 530 may include functionality for determining its location, direction, or orientation, based on integrated sensors such as GPS, compass, gyroscope, or accelerometer. User device 530 may also include wireless transceivers for wireless communication, and may support wireless communication protocols such as Bluetooth, near-field communication (NFC), infrared (IR) communication, WI-FI, and/or 2G/3G/4G/LTE mobile communication standard. User device 530 may also include one or more cameras, scanners, touchscreens, microphones, speakers, and any other suitable input-output devices.

In particular embodiments, the vehicle 540 may be an autonomous vehicle and equipped with an array of sensors 544, a navigation system 546, and a ride-service computing device 548. In particular embodiments, a fleet of autonomous vehicles 540 may be managed by the transportation management system 560. The fleet of autonomous vehicles 540, in whole or in part, may be owned by the entity associated with the transportation management system 560, or they may be owned by a third-party entity relative to the transportation management system 560. In either case, the transportation management system 560 may control the operations of the autonomous vehicles 540, including, e.g., dispatching select vehicles 540 to fulfill ride requests, instructing the vehicles 540 to perform select operations (e.g., head to a service center or charging/fueling station, pull over, stop immediately, self-diagnose, lock/unlock compartments, change music station, change temperature, and any other suitable operations), and instructing the vehicles 540 to enter select operation modes (e.g., operate normally, drive at a reduced speed, drive under the command of human operators, and any other suitable operational modes).

In particular embodiments, the autonomous vehicles 540 may receive data from and transmit data to the transportation management system 560 and the third-party system 570. Example of received data may include, e.g., instructions, new software or software updates, maps, 3D models, trained or untrained machine-learning models, location information (e.g., location of the ride requestor, the autonomous vehicle 540 itself, other autonomous vehicles 540, and target destinations such as service centers), navigation information, traffic information, weather information, entertainment content (e.g., music, video, and news) ride requestor information, ride information, and any other suitable information. Examples of data transmitted from the autonomous vehicle 540 may include, e.g., telemetry and sensor data, determinations/decisions based on such data, vehicle condition or state (e.g., battery/fuel level, tire and brake conditions, sensor condition, speed, odometer, etc.), location, navigation data, passenger inputs (e.g., through a user interface in the vehicle 540, passengers may send/receive data to the transportation management system 560 and/or third-party system 570), and any other suitable data.

In particular embodiments, autonomous vehicles 540 may also communicate with each other as well as other traditional human-driven vehicles, including those managed and not managed by the transportation management system 560. For example, one vehicle 540 may communicate with another vehicle data regarding their respective location, condition, status, sensor reading, and any other suitable information. In particular embodiments, vehicle-to-vehicle communication may take place over direct short-range wireless connection (e.g., WI-FI, Bluetooth, NFC) and/or over a network (e.g., the Internet or via the transportation management system 560 or third-party system 570).

In particular embodiments, an autonomous vehicle 540 may obtain and process sensor/telemetry data. Such data may be captured by any suitable sensors. For example, the vehicle 540 may have aa Light Detection and Ranging (LiDAR) sensor array of multiple LiDAR transceivers that are configured to rotate 360°, emitting pulsed laser light and measuring the reflected light from objects surrounding vehicle 540. In particular embodiments, LiDAR transmitting signals may be steered by use of a gated light valve, which may be a MEMs device that directs a light beam using the principle of light diffraction. Such a device may not use a gimbaled mirror to steer light beams in 360° around the autonomous vehicle. Rather, the gated light valve may direct the light beam into one of several optical fibers, which may be arranged such that the light beam may be directed to many discrete positions around the autonomous vehicle. Thus, data may be captured in 360° around the autonomous vehicle, but no rotating parts may be necessary. A LiDAR is an effective sensor for measuring distances to targets, and as such may be used to generate a three-dimensional (3D) model of the external environment of the autonomous vehicle 540. As an example and not by way of limitation, the 3D model may represent the external environment including objects such as other cars, curbs, debris, objects, and pedestrians up to a maximum range of the sensor arrangement (e.g., 50, 100, or 200 meters). As another example, the autonomous vehicle 540 may have optical cameras pointing in different directions. The cameras may be used for, e.g., recognizing roads, lane markings, street signs, traffic lights, police, other vehicles, and any other visible objects of interest. To enable the vehicle 540 to “see” at night, infrared cameras may be installed. In particular embodiments, the vehicle may be equipped with stereo vision for, e.g., spotting hazards such as pedestrians or tree branches on the road. As another example, the vehicle 540 may have radars for, e.g., detecting other vehicles and/or hazards afar. Furthermore, the vehicle 540 may have ultra sound equipment for, e.g., parking and obstacle detection. In addition to sensors enabling the vehicle 540 to detect, measure, and understand the external world around it, the vehicle 540 may further be equipped with sensors for detecting and self-diagnosing the its own state and condition. For example, the vehicle 540 may have wheel sensors for, e.g., measuring velocity; global positioning system (GPS) for, e.g., determining the vehicle's current geolocation; and/or inertial measurement units, accelerometers, gyroscopes, and/or odometer systems for movement or motion detection. While the description of these sensors provides particular examples of utility, one of ordinary skill in the art would appreciate that the utilities of the sensors are not limited to those examples. Further, while an example of a utility may be described with respect to a particular type of sensor, it should be appreciated that the utility may be achieving using any combination of sensors. For example, an autonomous vehicle 540 may build a 3D model of its surrounding based on data from its LiDAR, radar, sonar, and cameras, along with a pre-generated map obtained from the transportation management system 560 or the third-party system 570. Although sensors 544 appear in a particular location on autonomous vehicle 540 in FIG. 5, sensors 544 may be located in any suitable location in or on autonomous vehicle 540. Example locations for sensors include the front and rear bumpers, the doors, the front windshield, on the side paneling, or any other suitable location.

In particular embodiments, the autonomous vehicle 540 may be equipped with a processing unit (e.g., one or more CPUs and GPUs), memory, and storage. The vehicle 540 may thus be equipped to perform a variety of computational and processing tasks, including processing the sensor data, extracting useful information, and operating accordingly. For example, based on images captured by its cameras and a machine-vision model, the vehicle 540 may identify particular types of objects captured by the images, such as pedestrians, other vehicles, lanes, curbs, and any other objects of interest.

In particular embodiments, the autonomous vehicle 540 may have a navigation system 546 responsible for safely navigating the autonomous vehicle 540. In particular embodiments, the navigation system 546 may take as input any type of sensor data from, e.g., a Global Positioning System (GPS) module, inertial measurement unit (IMU), LiDAR sensors, optical cameras, radio frequency (RF) transceivers, or any other suitable telemetry or sensory mechanisms. The navigation system 546 may also utilize, e.g., map data, traffic data, accident reports, weather reports, instructions, target destinations, and any other suitable information to determine navigation routes and particular driving operations (e.g., slowing down, speeding up, stopping, swerving, etc.). In particular embodiments, the navigation system 546 may use its determinations to control the vehicle 540 to operate in prescribed manners and to guide the autonomous vehicle 540 to its destinations without colliding into other objects. Although the physical embodiment of the navigation system 546 (e.g., the processing unit) appears in a particular location on autonomous vehicle 540 in FIG. 5, navigation system 546 may be located in any suitable location in or on autonomous vehicle 540. Example locations for navigation system 546 include inside the cabin or passenger compartment of autonomous vehicle 540, near the engine/battery, near the front seats, rear seats, or in any other suitable location.

In particular embodiments, the autonomous vehicle 540 may be equipped with a ride-service computing device 548, which may be a tablet or other suitable device installed by transportation management system 560 to allow the user to interact with the autonomous vehicle 540, transportation management system 560, other users 501, or third-party systems 570. In particular embodiments, installation of ride-service computing device 548 may be accomplished by placing the ride-service computing device 548 inside autonomous vehicle 540, and configuring it to communicate with the vehicle 540 via a wire or wireless connection (e.g., via Bluetooth). Although FIG. 5 illustrates a single ride-service computing device 548 at a particular location in autonomous vehicle 540, autonomous vehicle 540 may include several ride-service computing devices 548 in several different locations within the vehicle. As an example and not by way of limitation, autonomous vehicle 540 may include four ride-service computing devices 548 located in the following places: one in front of the front-left passenger seat (e.g., driver's seat in traditional U.S. automobiles), one in front of the front-right passenger seat, one in front of each of the rear-left and rear-right passenger seats. In particular embodiments, ride-service computing device 548 may be detachable from any component of autonomous vehicle 540. This may allow users to handle ride-service computing device 548 in a manner consistent with other tablet computing devices. As an example and not by way of limitation, a user may move ride-service computing device 548 to any location in the cabin or passenger compartment of autonomous vehicle 540, may hold ride-service computing device 548 in his/her lap, or handle ride-service computing device 548 in any other suitable manner. Although this disclosure describes providing a particular computing device in a particular manner, this disclosure contemplates providing any suitable computing device in any suitable manner.

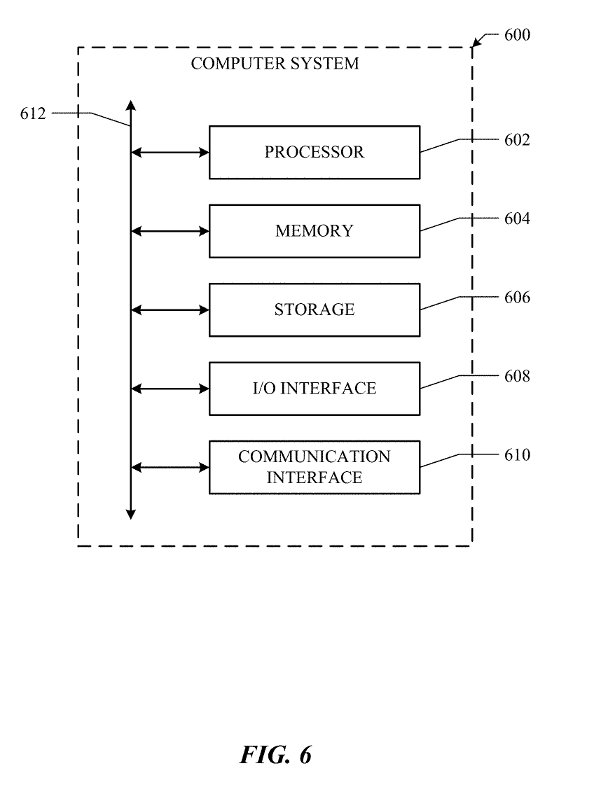

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described in further detail below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a Bluetooth WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
receiving an indication of an impaired sensor component from a first autonomous vehicle;
identifying a sensor type of the impaired sensor component;
determining a suitable service center for servicing the sensor type based on one or more criteria;
identifying a second autonomous vehicle, wherein the second autonomous vehicle has a functional sensor component of the sensor type;
sending instructions to the second autonomous vehicle to drive to a location of the first autonomous vehicle;
sending instructions to the first autonomous vehicle to drive to the service center location using sensor data of the second autonomous vehicle; and
sending instructions to the second autonomous vehicle to drive to the service center location with the first autonomous vehicle.

2. The method of claim 1, wherein the instructions to the second autonomous vehicle to drive to the service center location with the first autonomous vehicle comprises leading the first autonomous vehicle to the service center location.

3. The method of claim 2, further comprising:
sending instructions to the first autonomous vehicle to follow the second autonomous vehicle to the service center location.

4. The method of claim 1, wherein the one or more criteria comprises proximity of a service center to a current location of the first autonomous vehicle, specialty or skill level of a service center in fixing the impaired sensor component, user ratings associated with a service center, cost-effectiveness in fixing the impaired sensor component, availability of a service center, or estimated time in fixing the impaired sensor component.

5. The method of claim 1, wherein the suitable service center is one of:
a nearest service center if the impaired sensor component needs to be repaired immediately or the first autonomous vehicle is unsafe to drive with the impaired sensor component;
a specialty service center if the impaired sensor component is designated to be repaired by one or more specialized technicians working at the specialty service center location who are skilled in repairing the sensor component; or
a best service center if the first autonomous vehicle is safe to drive with the impaired sensor component and the impaired sensor component is repairable at any service center location, wherein the best service center has cost savings and high service ratings.

6. The method of claim 1, wherein identifying the second autonomous vehicle comprises:
identifying a vacant autonomous vehicle within a threshold distance of a location of the first autonomous vehicle that has the functional sensor component of the sensor type.

7. The method of claim 1, further comprising:
sending instructions to the second autonomous vehicle to share sensor data from the functional sensor component of the second autonomous vehicle with the first autonomous vehicle, wherein the first autonomous vehicle is instructed to drive to the service center location using the sensor data shared by the second autonomous vehicle.

8. The method of claim 1, further comprising:
receiving an indication that a passenger is riding in the first autonomous vehicle;
determining a destination location of the passenger;
sending instructions to the first autonomous vehicle to drive to the destination location of the passenger to drop-off the passenger using the sensor data of the second autonomous vehicle prior to driving to the service center location; and
sending instructions to the second autonomous vehicle to drive to the destination location of the passenger with the first autonomous vehicle.

9. The method of claim 1, wherein the sensor component is an object-detection component for detecting objects around the first autonomous vehicle, and wherein the sensor data of the second autonomous vehicle is used by the first autonomous vehicle to detect the objects.

10. A computing system comprising: one or more processors and one or more computer-readable non-transitory storage media coupled to one or more of the processors, the one or more computer-readable non-transitory storage media comprising instructions operable when executed by one or more of the processors to cause the computing system to perform operations comprising:
receiving an indication of an impaired sensor component from a first autonomous vehicle;
identifying a sensor type of the impaired sensor component;
determining a suitable service center for servicing the sensor type based on one or more criteria;
identifying a second autonomous vehicle, wherein the second autonomous vehicle has a functional sensor component of the sensor type;
sending instructions to the second autonomous vehicle to drive to a location of the first autonomous vehicle;
sending instructions to the first autonomous vehicle to drive to the service center location using sensor data of the second autonomous vehicle; and
sending instructions to the second autonomous vehicle to drive to the service center location with the first autonomous vehicle.

11. The computing system of claim 10, wherein the processors are further operable when executing the instructions to perform operations comprising:
sending instructions to the first autonomous vehicle to follow the second autonomous vehicle to the service center location.

12. The computing system of claim 10, wherein the sensor component is an object-detection component for detecting objects around the first autonomous vehicle, and wherein the sensor data of the second autonomous vehicle is used by the first autonomous vehicle to detect the objects.

13. The computing system of claim 10, wherein the one or more criteria comprises proximity of a service center to a current location of the first autonomous vehicle, specialty or skill level of a service center in fixing the impaired sensor component, user ratings associated with a service center, cost-effectiveness in fixing the impaired sensor component, availability of a service center, or estimated time in fixing the impaired sensor component.

14. The computing system of claim 10, wherein the processors are further operable when executing the instructions to perform operations comprising:
receiving an indication that a passenger is riding in the first autonomous vehicle;
determining a destination location of the passenger;
sending instructions to the first autonomous vehicle to drive to the destination location of the passenger to drop-off the passenger using the sensor data of the second autonomous vehicle prior to driving to the service center location; and
sending instructions to the second autonomous vehicle to drive to the destination location of the passenger with the first autonomous vehicle.

15. The computing system of claim 10, wherein, to identify the second autonomous vehicle, the processors are further operable when executing the instructions to perform operations comprising:
identifying a vacant autonomous vehicle within a threshold distance of a location of the first autonomous vehicle that has the functional sensor component of the sensor type.

16. One or more computer-readable non-transitory storage media embodying software that is operable when executed to cause one or more processors to perform operations comprising:
receiving an indication of an impaired sensor component from a first autonomous vehicle;
identifying a sensor type of the impaired sensor component;
determining a suitable service center for servicing the sensor type based on one or more criteria;
identifying a second autonomous vehicle, wherein the second autonomous vehicle has a functional sensor component of the sensor type;
sending instructions to the second autonomous vehicle to drive to a location of the first autonomous vehicle;
sending instructions to the first autonomous vehicle to drive to the service center location using sensor data of the second autonomous vehicle; and
sending instructions to the second autonomous vehicle to drive to the service center location with the first autonomous vehicle.

17. The media of claim 16, wherein the software is further operable when executed to cause the one or more processors to perform operations comprising:
sending instructions to the first autonomous vehicle to follow the second autonomous vehicle to the service center location.

18. The media of claim 16, wherein the sensor component is an object-detection component for detecting objects around the first autonomous vehicle, and wherein the sensor data of the second autonomous vehicle is used by the first autonomous vehicle to detect the objects.

19. The media of claim 16, wherein the one or more criteria comprises proximity of a service center to a current location of the first autonomous vehicle, specialty or skill level of a service center in fixing the impaired sensor component, user ratings associated with a service center, cost-effectiveness in fixing the impaired sensor component, availability of a service center, or estimated time in fixing the impaired sensor component.

20. The media of claim 16, wherein the software is further operable when executed to cause the one or more processors to perform operations comprising:
receiving an indication that a passenger is riding in the first autonomous vehicle;
determining a destination location of the passenger;
sending instructions to the first autonomous vehicle to drive to the destination location of the passenger to drop-off the passenger using the sensor data of the second autonomous vehicle prior to driving to the service center location; and
sending instructions to the second autonomous vehicle to drive to the destination location of the passenger with the first autonomous vehicle.
